(19) United States
(12) Patent Application Publication
(10) Pub. No.: US 2015/0081964 A1
(43) Pub. Date: Mar. 19, 2015

(54) MANAGEMENT APPARATUS AND MANAGEMENT METHOD OF COMPUTING SYSTEM

(71) Applicants: Kenichi Kihara, Yokohama (JP); Junichi Hara, Sagamihara (JP); Yukinori Sakashita, Sagamihara (JP)

(72) Inventors: Kenichi Kihara, Yokohama (JP); Junichi Hara, Sagamihara (JP); Yukinori Sakashita, Sagamihara (JP)

(73) Assignee: HITACHI, LTD., Chiyoda-ku, Tokyo (JP)

(21) Appl. No.: 13/579,722

(22) PCT Filed: May 1, 2012
(86) PCT No.: PCT/JP2012/061538

§ 371 Date: Aug. 17, 2012

(51) Int. Cl. G06F 3/06; G06F 12/02

(52) U.S. Cl. CPC G06F 3/0665; G06F 3/0689; G06F 3/0619; G06F 12/02
USPC 711/114

(57) ABSTRACT

Tier management is performed immediately in response to the priority level of an object. A priority level is determined for each of two or more objects included in a specific computer program. A physical memory area is extracted that is a relocation target for each of the two or more objects. Using a management apparatus, a specific physical memory area is selected from the physical memory areas that are relocation targets based on the priority level for each of the objects. The management apparatus instructs a storage apparatus to allocate data stored in the selected specific physical memory area to the physical memory area in a specific storage tier.

### TECHNICAL FIELD

The present invention relates to a management apparatus and a management method of a computing system.

### BACKGROUND ART

A storage system including a so-called thin provisioning function is known. In the thin provisioning function, a memory area of a volume is regarded as a memory unit aggregation that is called a page. When writing of data is performed on a page, a physical memory area is assigned to the page. Thus, in a virtual logical volume using the thin provisioning function, a logical capacity in excess of a physical storage capacity is allowed to be defined. In addition, the concentration of an input/output (I/O) load for the virtual logical volume is allowed to be suppressed by distributedly allocating a page to two or more storage tiers.

As an application technology of the thin provisioning function, a page relocation technology is known in which a page is allocated so as to be distributed to two or more storage tiers (tiers), and data of the page is migrated between the different storage tiers as appropriate (Patent Literature 1). In Patent Literature 1, an input/output (I/O) amount of each of the pages is measured at a specific interval, and the data of the page is migrated to a different tier based on the I/O amount.

In addition, a function is known in which data in a virtual logical volume is stored in a mere specific tier and is not migrated to another tier (Patent Literature 2). The technology that achieves the function is called an object-based tier management technology.

Here, an object belongs to a specific computer program and indicates a function unit or memory unit including a data area. For example, in a database management system (hereinafter referred to as DBMS), a table or an index is an object. In Patent Literature 2, the arrangement of the object is checked, and a page that is a storage destination of the object is identified. The identified page is migrated to a specific tier, so that the data of the object is allocated to the mere specific tier.

In addition, a technology is known in which relocation of a page is optimized by focusing on a relocation time of data (Patent Literature 3).

### CITATION LIST

### Patent Literature

[Patent Literature 1] International Publication No. WO 2011/077489
[Patent Literature 2] Japanese Patent Laid-Open No. 2011-170833
[Patent Literature 3] International Publication No. WO 2011/096017

### SUMMARY OF INVENTION

### Technical Problem

When an object-based tier management function is achieved using the technology in Patent Literature 1, embodiments described below may be conceived. That is, an administrator specifies a data storage destination tier for each object with respect to the management program beforehand. The management program specifies an allocation destination tier of each page to a storage system based on the relation of the object and the page, and the specified contents from the administrator. The storage system relocates the page in consideration of the contents of an instruction in the execution cycle of a specific page relocation process. In such case, a large number of relocation target pages may be generated depending on contents of an instruction from the administrator. As a result, it takes a long time to process the page relocation. Thus, it is probable that the progress of page relocation in an object to be processed more immediately is stacked up.

The present invention has been made in view of the above-described problems, and an object of the present invention is to provide a management apparatus and a management method of a computing system, in which a physical memory area used by an object is allowed to be provided between two or more storage tiers based on a priority level determined for each of the objects.

### Solution to Problem

In order to solve the above-described problems, a management apparatus according to the present invention is a management apparatus for managing a computing system including at least one host computer and at least one storage apparatus, and the storage apparatus including at least one virtual logical volume that is supplied to a specific computer program operating in the host computer and at least one pool that includes two or more storage tiers that include different performances and executing a relocation process in which a virtual memory area comprised in the virtual logical volume is associated with a physical memory area of any of the two or more storage tiers in response to a write request from the host computer, and the physical memory area associated with the virtual memory area is allocated to a specific storage tier of the two or more storage tiers based on specific specification information for instructing a relocation destination. The management apparatus includes a memory that is configured to store a management program for performing tier management for the two or more storage tiers, and a microprocessor that is configured to execute the management program stored in the memory, the specific specification information being stored in the memory and holding information for identifying a specific storage tier in which data of two or more objects related to the specific computer program is to be stored, and the microprocessor causes the management program to execute: as a first tier management mode, a priority level determination step of determining each priority level of each of the two or more objects based on priority level management information for determining a priority level related to relocation for each of the two or more objects included in the specific computer program; a relocation information generation step of extracting a physical memory area that is a relocation target for each of the two or more objects based on the specific specification information and storage state information indicating a current storage destination of the physical memory area corresponding to the virtual memory area; a selection step of selecting a specific physical memory area from the extracted physical memory areas that are relocation targets based on the priority level determined for each of the two or more objects; and an instruction step of instructing the storage apparatus to allocate data stored in the selected specific physical memory area to the physical memory area in the specific storage tier indicated in the specification information.

In the selection step, the specific physical memory area is allowed to be selected based on a priority level in a range of an upper limit value determined from a relocation performance included in the storage apparatus.

The priority level management information is allowed to be created beforehand based on the attribute of an object.

The further features of the present invention will become apparent from the description of the present specification and the accompanying drawings. In addition, the aspect of the present invention is realized by being accomplished from elements, combination of various elements, the following detailed description, etc.

It should be understood that the description of the present specification is only exemplary, and should not, in any sense, be intended to limit the claims or application example of the present invention.

### BRIEF DESCRIPTION OF DRAWINGS

FIG. 1 illustrates an arrangement of an object-based tier management system.

FIG. 2 illustrates a relation of an object of a DBMS and a page relocation process.

FIG. 3 illustrates a main flow of information in an object storage destination specification.

FIG. 4 illustrates information of the object storage destination specification.

FIG. 5 illustrates information of a DBMS priority level evaluation policy.

FIG. 6 illustrates information of object priority level evaluation.

FIG. 7 illustrates information of an object storage state.

FIG. 8 illustrates information of object relocation.

FIG. 9 illustrates information of pool management.

FIG. 10 illustrates information of a page storage state.

FIG. 11 illustrates information of page storage destination specification.

FIG. 12 illustrates information of an object arrangement.

FIG. 13 illustrates information of object performance.

FIG. 14 illustrates a flowchart of a process in the object storage destination specification.

FIG. 15 illustrates a flowchart of a process in the page storage destination specification when back pages are not priority.

FIG. 16 illustrates a flowchart of the first half of a process in the page storage destination specification when back pages are priority.

FIG. 17 illustrates a flowchart of the latter half of a process in the page storage destination specification when back pages are priority.

FIG. 18 illustrates a flowchart of a process in the page relocation.

FIG. 19 illustrates a display screen of a list of the DBMS.

FIG. 20 illustrates an edit screen of the object storage destination.

FIG. 21 illustrates a check screen of configuration contents of the object storage destination.

FIG. 22 illustrates a display screen of a list of the DBMS after object storage destination edit.

FIG. 23 illustrates a detailed display screen of a page relocation execution status.

FIG. 24 illustrates a configuration of an object-based tier management system according to a second embodiment.

FIG. 25 illustrates a relation of a guest OS and a page relocation process.

FIG. 26 illustrates contents of a virtual disk.

FIG. 27 illustrates information of virtual disk storage destination specification.

FIG. 28 illustrates information of a guest OS priority level.

FIG. 29 illustrates information of a virtual disk storage state.

FIG. 30 illustrates information of virtual disk relocation.

FIG. 31 illustrates information of a guest OS arrangement.

FIG. 32 illustrates information of a virtual disk performance.

FIG. 33 illustrates a flowchart of a process in the virtual disk storage destination specification.

FIG. 34 illustrates a display screen of a list of hypervisor;

FIG. 35 illustrates an edit screen of a virtual disk storage destination.

FIG. 36 illustrates a check screen of the configuration contents of a virtual disk storage destination.

FIG. 37 illustrates scaling of the object;

FIG. 38 illustrates a relation of expansion of the object and page relocation.

FIG. 39 illustrates information of DBMS priority level evaluation policy according to a third embodiment.

FIG. 40 illustrates information of DBMS priority level evaluation policy according to a fourth embodiment.

FIG. 41 illustrates a flowchart of a calculation process of an assignment time for each DBMS.

FIG. 42 illustrates a flowchart subsequent to FIG. 41.

FIG. 43 illustrates estimated contents of a method using a weight value for correcting a page relocation amount for each DBMS.

### DESCRIPTION OF EMBODIMENTS

Embodiments of the present invention are described below with reference to the accompanying drawings. In the accompanying drawings, functionally the same element may be indicated by the same number. It is noted that the accompanying drawings illustrate specific embodiments and examples according to the principle of the present invention. The embodiments and examples are intended for the understanding of the present invention and should not be used to interpret the present invention to a limited extent.

In the embodiments, the descriptions are made in sufficient detail to enable those skilled in the art to practice the invention, and alternatively, it is also possible to apply to another implementation or embodiment. It should be understood that the change of arrangement or structure, and replacement of various elements are possible without departing from the scope and spirit of the technical concept of the present invention. Therefore, the following description should not be interpreted to a limited extent.

In addition, as described later, the embodiments of the present invention may be implemented in software that operates on a general-purpose computer, implemented in dedicated hardware, or implemented in the combination of the software and the hardware.

It is noted that, as described below, each piece of information of the present invention is explained by a “table” format, the information is not necessarily expressed by a data structure by the table, and alternatively, the information may be expressed by a data structure such as a list, a database (DB), and a queue. Therefore, “table,” “list,” “DB,” “queue,” etc. may be merely referred to as “information” in order to indicate that the expression is independent of the data structure.

In addition, when the contents of each pieces of information are explained, “identification information,” “identifier,” “title,” “name,” and “ID” may be used, it is possible that these are substituted each other.

In the embodiments of the present invention, each of the processes is explained below using “program” as a subject (subject of the action), and a processor may be used as a subject because the program executes a process defined so as to be executed by the processor using a memory and a communication port (communication control apparatus). In addition, the process discussed using “program” as a subject may be a process performed by a computer or an information processing apparatus such as a management server. A part of the program or the whole program may be realized by dedicated hardware, and may be modularized. Various programs may be installed to each computer by a program distribution server and a storage media.

According to the embodiments, in an object-based tier management system, a page relocation process for an object may be executed more properly. As a result, the occurrence of an event in which tier optimization of an object to be immediately processed is stacked up may be suppressed.

### First Embodiment

Embodiments according to the present invention are described below in accordance with the drawings. In the drawings, for convenience, the names of some elements are simplified and described.

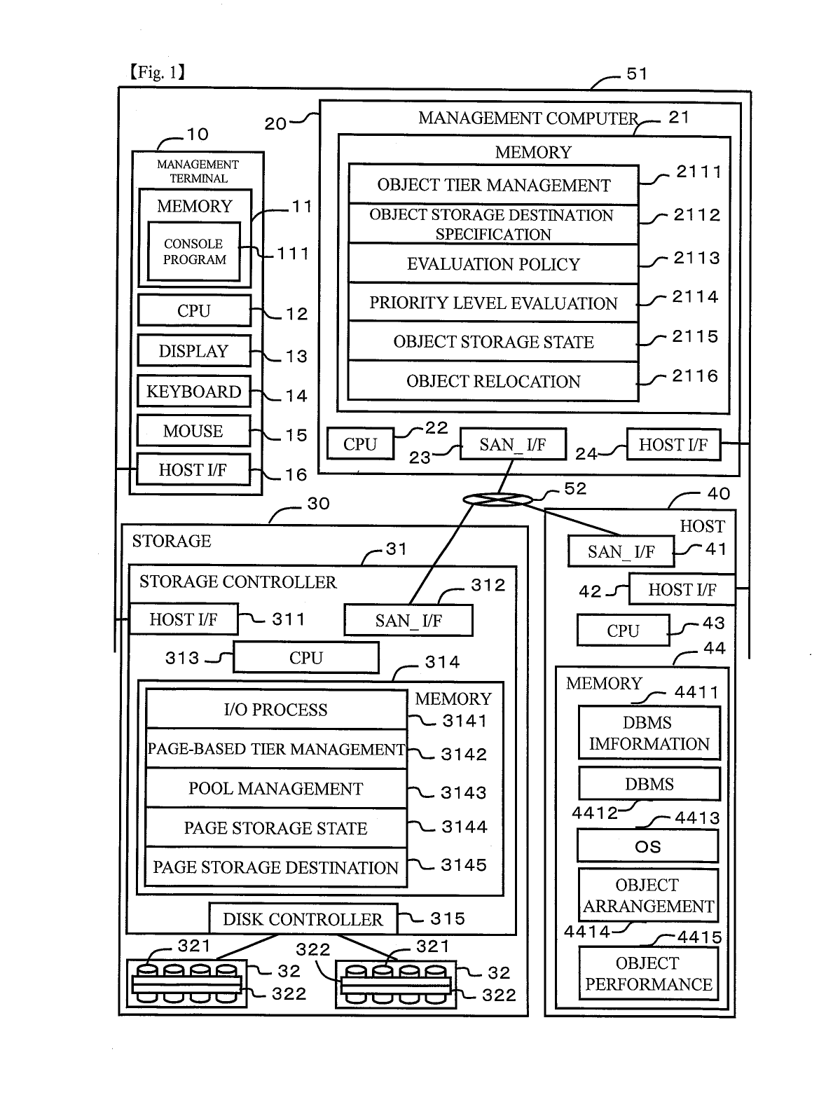

FIG. 1 illustrates a general arrangement of a computing system according to a first embodiment. The computing system includes, for example, at least one management terminal 10, at least one management computer 20, at least one storage 30, at least one host computer 40, a management network 51, and a storage network 52. The host computer may be abbreviated as “host.”

The management terminal 10, the management computer 20, each of the storages 30, and the host computer 40 are bidirectionally communicatively connected to each other through the management network 51. In addition, the management computer 20, each of the storages 30, and the host computer 40 are bidirectionally communicatively connected to each other through the storage network 52.

The management network 51 and the storage network 52 are communication lines and communication paths for transmitting and receiving data between information processing apparatuses. It is noted that, in FIG. 1, the management network 51 and the storage network 52 are indicated as different communication lines, and the networks 51 and 52 may be configured to be used as a shared communication line.

The management terminal 10 is an information processing apparatus and includes, for example, a memory 11, a microprocessor (central process unit (CPU) in the drawings) 12, a display apparatus 13, a keyboard 14, a mouse 15, and a host interface (hereinafter, interface is referred to as I/F) 16.

The memory 11 stores data and a computer program. The microprocessor (hereinafter, referred to as processor) 12 executes the computer program by reading the computer program from the memory 11. The display apparatus 13 displays data, etc. The keyboard 14 accepts an input of a character from a user. The mouse 15 is used for indicating a specific point on a screen displayed by the display apparatus. The host I/F 16 transmits and receives data to and from the management computer 20 through the management network 51. For example, an indication apparatus by voice and an indication apparatus by a brain wave may be used as a user interface in addition to the display apparatus, the keyboard, and the mouse.

In the memory 11, a console program 111 is stored. The microprocessor 12 executes the console program 111, so that a function is realized such as a function that exchanges data with the management computer 20 through the host I/F 16 and the management network 51, a function that displays information on the display apparatus 13, and a function that accepts an input from the user through the keyboard 14 and the mouse 15.

The management terminal 10 is used as a front terminal for operating and managing the storage 30 by the user (storage administrator) involved in the operation and management of storage. The management terminal 10 may be configured to be used as a personal computer (PC), a personal digital assistant, a mobile phone, a terminal for operation, etc. Alternatively, a man-machine interface function included in the management terminal 10 may be configured to be provided in the management computer 20.

The management computer 20 is an information processing apparatus that manages a computing system, and includes, for example, a memory 21, a processor 22, a SAN I/F 23, and a host I/F 24.

The memory 21 stores data, a computer program, and management information. The processor 22 executes the computer program by reading the computer program from the memory 21. The processor 22 executes the computer program, so that each function described later is realized.

The SAN I/F 23 is a circuit for issuing an operation instruction or an information query to each of the storages 30 through the storage network 52. The host I/F 24 is a circuit for performing data communication with other information processing apparatuses 10, 30, and 40 through the management network 51.

An object tier management program 2111 is a computer program for managing the storage 30 in cooperation with a DBMS data collection program 4411 on the host 40 and is stored in the memory 21.

Object storage destination specification information 2112 is definition information for indicating a tier in which an object in a DBMS 4412 is to be stored. For example, an index and a table are examples of an object. DBMS priority level evaluation policy information (evaluation policy in the drawings) 2113 is definition information for indicating an evaluation method of a priority level for each of the DBMSs 4412.

Object priority level evaluation information (priority level evaluation in the drawings) 2114 is information for indicating the priority level of page relocation of an object in the DBMS 4412. That is, the object priority level evaluation information 2114 manages the priority level of a relocation process in a page storing data of an object. In the first embodiment as described later, a page related to an object having a high priority level, is relocated on a priority basis.

Object storage state information 2115 is information for indicating a tier in which an object in the DBMS 4412 is actually stored. That is, the object storage state information 2115 manages a tier in which a page storing data of an object actually exists.

Object relocation information 2116 is information related to a page relocation target of an object in the DBMS 4412.

The object tier management program 2111, the object storage destination specification information 2112, the DBMS priority level evaluation policy information 2113, the object priority level evaluation information 2114, the object storage state information 2115, and the object relocation information 2116 are stored in the memory 21. Each of the pieces of the information 2111, 2112, 2113, 2114, 2115, and 2116 are described in detail later.

It is noted that, in FIG. 1, a case is indicated in which the management computer 20 and the host computer 40 are provided separately, and alternatively, the host computer 40 may function as a management computer. For example, at least one of the two or more host computers 40 may be configured to be provided with a computer program 211 and various pieces of management information 2111 to 2116 included in the management computer 20.

The storage 30 that serves as a “storage apparatus” is an apparatus for storing information. In FIG. 1, one storage 30 is indicated, and alternatively, the computing system may include two or more storages 30. Each of the storages 30 includes, for example, a storage controller 31 and a disk unit 32.

A storage controller 31 includes a host I/F 311, a SAN I/F 312, a microprocessor 313, a memory 314, and a disk controller 315. The host I/F 311 is a circuit for being connected to the management network 51. The SAN I/F 312 is a circuit for being connected to the storage network 52.

In the memory 314, for example, an I/O processing program (I/O processing in the drawings) 3141, a page-based tier management program (page tier management in the drawings) 3142, pool management information 3143, page storage state information 3144, and page storage destination specification information 3145 are stored.

The microprocessor 313 executes the computer programs 3141 and 3142, and the management information 3143 by reading the programs and information. The disk controller 315 controls reading and writing of data from and to the disk drive 321.

The disk unit 32 includes two or more disk drives 321. Physical memory areas included in disk drives 321, respectively, are grouped, and two or more logical memory areas may be configured to the grouped physical memory area. The logical memory area is referred to as a logical volume 322.

For example, various apparatuses such as a hardware disk drive, a semiconductor memory drive, an optical disk drive, an optical magnetic disk drive on which reading and writing of data may be performed are available as a disk drive.

In a case of the hardware disk drive, for example, a Fibre Channel (FC) disk, a Small Computer System Interface (SCSI) disk, Serial AT Attachment (SATA) disk, AT Attachment (ATA) disk, Serial Attached SCSI (SAS) disk, etc. may be used.

In addition, for example, various storage apparatuses such as a flash memory, a Ferroelectric Random Access Memory (FeRAM), a Magnetoresistive Random Access Memory (MRAM), a Phase-change memory (Ovonic Unified Memory), and RRAM (registered trademark) may be used as a disk drive.

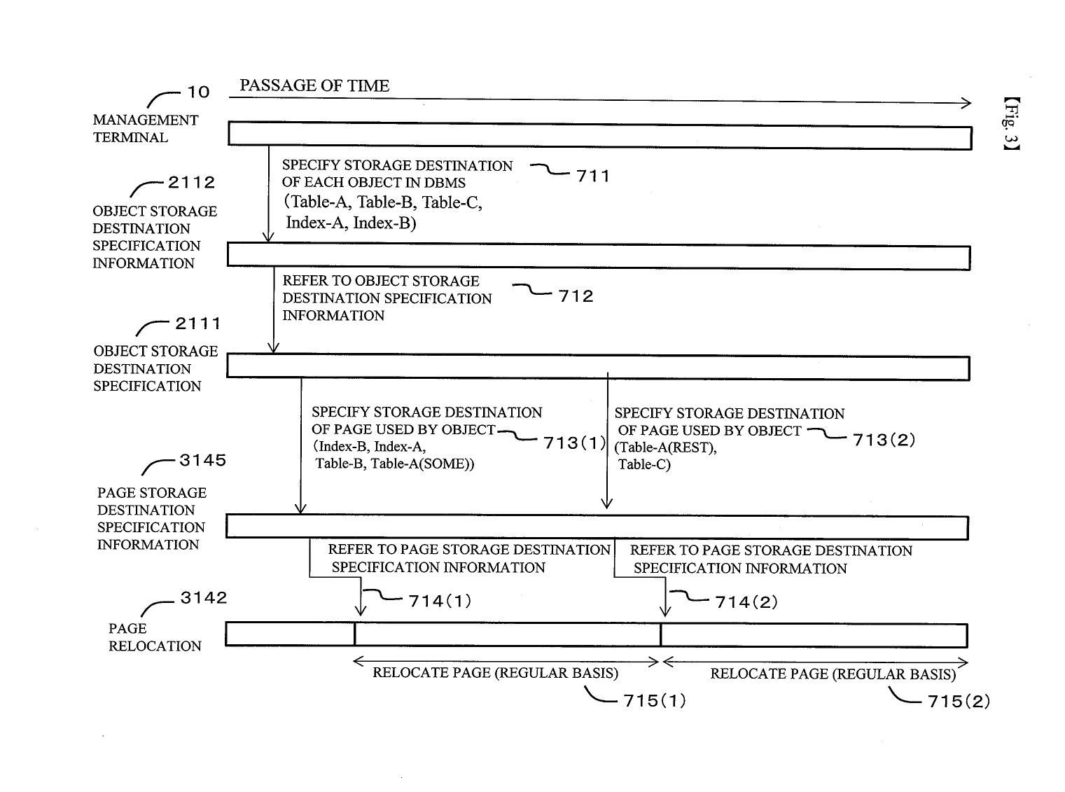

The I/O processing program 3141 defines the logical volume 322 in response to a request from the management computer 20. In addition, the I/O processing program 3141 performs reading and writing of data on the logical volume 322 and a virtual volume 351 (described later in FIG. 3) in response to the request from the host computer 40.

The page-based tier management program 3142 controls the so-called thin provisioning function. That is, the page-based tier management program 3142 makes available configuration management of a pool, operation management of a pool, configuration management of a virtual volume, operation management of a virtual volume, a function such as data reading and writing, and a page-based tier management function. The page-based tier management function (function that manages a tier in a page unit) includes functions such as operation status management of a page, relocation of a page. The page-based tier management program 3142 performs various operations, and configuration and reference of information in response to an instruction from the object tier management program 2111.

The pool management information 3143, the page storage state information 3144, and the page storage destination specification information 3145 are described in detail later.

The host computer 40 is an information processing apparatus using the storage 30 and includes, for example, a SAN I/F 41, a host I/F 42, a processor 43, and a memory 40.

The SAN I/F 41 is a circuit for data communication with each of the storages 30 through a storage network 52. The host I/F 42 is a circuit for data communication with the management computer 20 through the management network 51.

In a memory 44, for example, a DBMS data collection program (DBMS information in the drawings) 4411, the DBMS 4412, an Operating System (OS) 4413, the object arrangement information 4414, and object performance information 4415 are stored. The processor 43 executes each of the computer programs 4411, 4412, and 4413 by reading the programs.

The DBMS data collection program 4411 is a program that collects information related to the DBMS 4412 and transmits the information to the management computer 20. The DBMS data collection program 4411 provides the object arrangement information 4414 and the object performance information 4415 for the object tier management program 2111 based on an instruction from the object tier management program 2111. The object arrangement information 4414 is information for indicating the arrangement of an object in the DBMS 4412. The object performance information 4415 is information for indicating the performance of an object in the DBMS 4412.

The DBMS 4412 as an example of a “specific computer program” is a database management system and is a program for making available a function such as registration, update, and query of various data.

The OS 4413 is basic software that is an execution infrastructure for the DBMS data collection program 4411 and the DBMS 4412.

The object arrangement information 4414 and object performance information 4415 are described later.

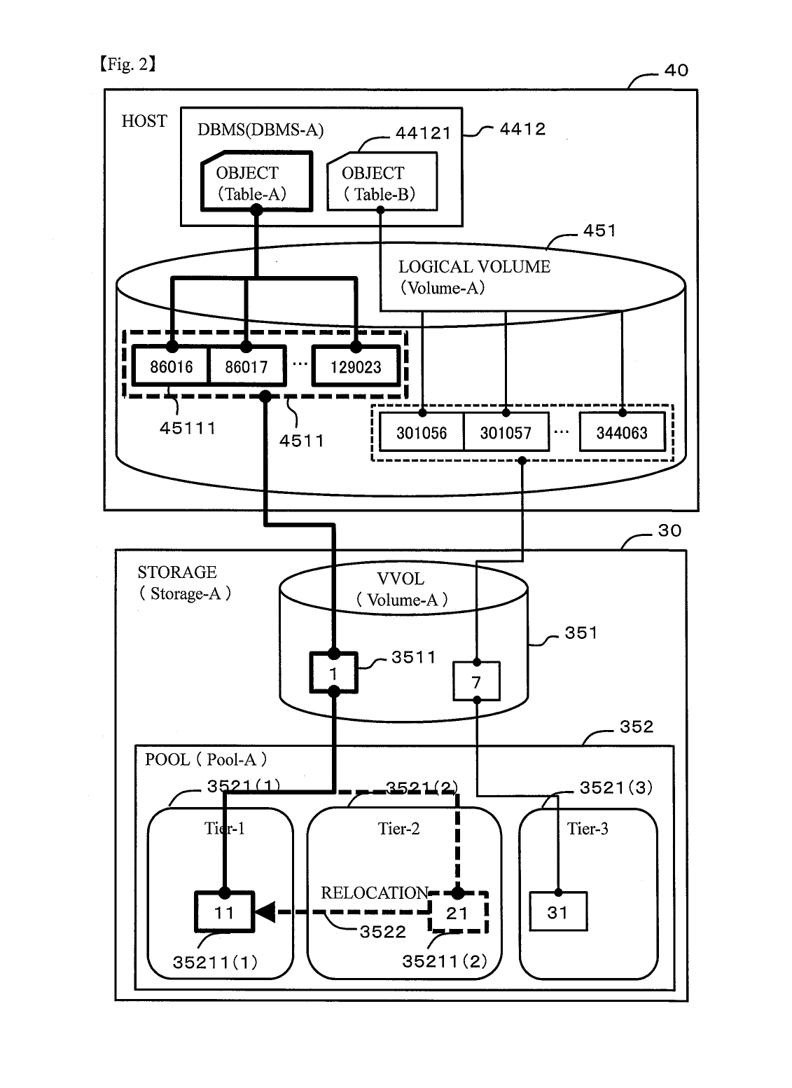

FIG. 2 schematically illustrates a relation of a storage method of data and page relocation 3522 in an object 44121 in the DBMS 4412.

In the DBMS 4412, two or more objects 44121 exist. The object 44121 is, for example, a memory unit of data such as a table or an index. The object 44121 is stored in a logical block 45111 in a logical volume 451.

The logical volume 451 is provided by the storage 30. The logical volume 451 is a memory unit that is recognized by the host 40. The logical block 45111 is a unit of a memory area comprised in the logical volume 451. The DBMS 4412 reads and writes data in a unit of the logical block 45111. Generally, the logical block 45111 is identified by an identification number called a Logical Block Address (LBA).

In FIG. 2, for example, a number such as “86016” and “86017” is displayed in the logical block 45111. The number indicates the LBA of the logical block 45111.

In FIG. 2, the two or more logical blocks 45111 are enclosed by one broken line 4511. The range 4511 indicated by the broken line indicates a range of a page that is a memory unit in a case in which the thin provisioning technology is used. A page 4511 in the logical volume 451 is associated with a page 3511 in a virtual volume 351 in the storage 30.

For example, the page 4511 in the logical volume 451 may be called a logical page, a page in the virtual volume 351 may be called a virtual page 3511, a page 35211 in a tier 3521 described later may be called a physical page.

The virtual volume 351 is a memory unit that is on the storage 30 side and is associated with the logical volume 451 on the host 40 side. The virtual volume 351 comprises the one or more pages 3511.

The page 3511 is a memory unit used in the thin provisioning function. The page 3511 is associated with the page 35211 in the tier 3521 including a physical storage medium in a pool 352.

It is noted that, in FIG. 2, a numeric character given in the virtual page 3511 is an identification number for uniquely identifying the virtual page 3511 in the virtual volume 351, that is, a page address.

In the first embodiment, an LBA 45111 (addresses of the logical block 45111) in the logical volume 451 and a page address of the virtual page 3511 may be converted simply mutual.

For example, a case is described in which the size of the logical block 45111 is 512 bytes, and the size of the virtual page 3511 is 42 megabytes. A page address corresponding to an LBA having a value “86016” is “1” obtained by multiplying the value of the LBA by 512 and dividing the value by 44040192 that is a value having 42 megabytes (=86016×512/44040192). An LBA and a page address of the virtual page 3511 may be associated with each other by a specific method, the first embodiment is not limited to the above-described example.

The pool 352 is a memory area including two or more tiers 3521 (1), 3521 (2), and 3521 (3). The pool 352 is associated with the virtual volume 351. When the tiers are not particularly distinguished, the tiers are called the tier 3521.

Each of the tier 3521 (1), tier 3521 (2), and tier 3521 (3) is a memory area that comprises one or more types of physical storage medium. For example, the upper tier 3521 (1) comprises a memory area included in a disk drive 321 having a relatively high performance. The middle tier 3521 (2) comprises a memory area included in the disk drive 321 having a moderate performance. The lower tier 3521 (3) comprises a memory area included in the disk drive 321 having a relatively low performance. The performance includes, for example, a speed of reading and writing of data, etc.

The page 35211 (1) in the tier 3521 (1) is a memory area in the tier 3521 (1). A numeric character given in the page 35211 (1) is an identification number that uniquely identifies the page 35211 (1) in the tier 3521 (1). That is, the identification number is a page address in the tier 3521 (1). In addition, another page (physical page) 35211 is similar to the page 35211 (1). A number given in the page is an identification number (page address) in the tier 3521.

Data of the page 35211 (2) in the tier 3521 (2) may be transferred to another tier 3521 (1) by the function of the page-based tier management program 3142. The data transfer process is called the page relocation 3522. The page relocation 3522 simply copies data and changes the association of the virtual page 3511 and the physical page 35211. That is, the page relocation 3522 performs process for changing the association destination of the virtual page 3511 from a physical page 35211 (2) that is a source, to the physical page 35211 (1) that is a destination.

Before an object tier management system is described in detail, the outline of a distinctive process executed in the first embodiment is described. A reference numeral of an object is omitted as appropriate.

FIG. 3 illustrates a flow of a main process in a case in which a storage destination of an object is identified. An administrator, etc. of the DBMS 4412 specifies a storage destination of each of the objects in the DBMS 4412 for the object storage destination specification information 2112 using the management terminal 10 (711 in FIG. 3).

In a process for specifying a storage destination of an object in the object tier management program 2111, the contents of the object storage destination specification information 2112 is referred to (712 in FIG. 3). In addition, in an object storage destination specification process, a storage destination of a page used by an object is specified for the page storage destination specification information 3145 in the order of an object having higher priority level (713 (1) in FIG. 3). In the first specification, in the object storage destination specification process, the storage destination of the page used by the object is specified in a range in which the process is allowed to be performed by one time portion of a page relocation process that is periodically performed (713 (1)).

The range in which the process is allowed to be performed by one time portion of the page relocation process is, for example, a range of the number of upper limit pages in which relocation is allowed to be performed by one time portion of the page relocation process. In the range of the number of upper limit pages in which the relocation is allowed to be performed, the storage destination of the page used by the object is specified. As described later, when the number of pages of relocation target (the number of pages used by an object) exceeds the number of upper limit pages in which the relocation is allowed to be performed, a relocation process of a page of the exceeding portion is performed next time.

The page-based tier management program 3142 periodically executes page relocation. The page-based tier management program 3142 refers to the contents of the page storage destination specification information 3145 just before the start of execution of the page relocation (714 (1) in FIG. 3), and executes the page relocation based on the contents (715 (1) in FIG. 3).

In the object storage destination specification process of the object tier management program 2111, a storage destination of a page used by an object having a low priority level is specified after the start of first page relocation 715 (1) (713 (2)). That is, in the object storage destination specification process, the storage destination of the page used by the object having a low priority level that is not specified in the object storage destination specification 713 (1) is specified (713 (2)).

In the page relocation process of the page-based tier management program 3142, the contents of the page storage destination specification information 3145 is referred to just before the start of the execution of next page relocation (714 (2)), the page relocation is executed (715 (2)).

As described below, the object tier management program 2111 adjusts the storage destination specification of the page used by an object to fit the page relocation executed by the page-based tier management program 3142. As a result, in the first embodiment, a page used by an object having a high priority level is allowed to be relocated to a specified tier more immediately than a page used by an object having a low priority level. The object storage destination specification process is described in detail later.

In the first embodiment, a priority level of page relocation is configured beforehand for each object, and a page included in an object is relocated depending on the priority level. When the priority level of an object is high, each of the pages included in the object is relocated on a priority basis. That is, the method of the first embodiment is different from a method in which relocation is performed for each of the pages based on usage frequency (the number of I/Os) of each of the pages. In the first embodiment, when usage frequency of a page included in an object having a high priority level, the page becomes a target of priority relocation. Even a page included in an object having a high priority level may not become a target of the first page relocation process because the number of upper limit pages in which the process is allowed to be performed by one time required for the page relocation process is limited.

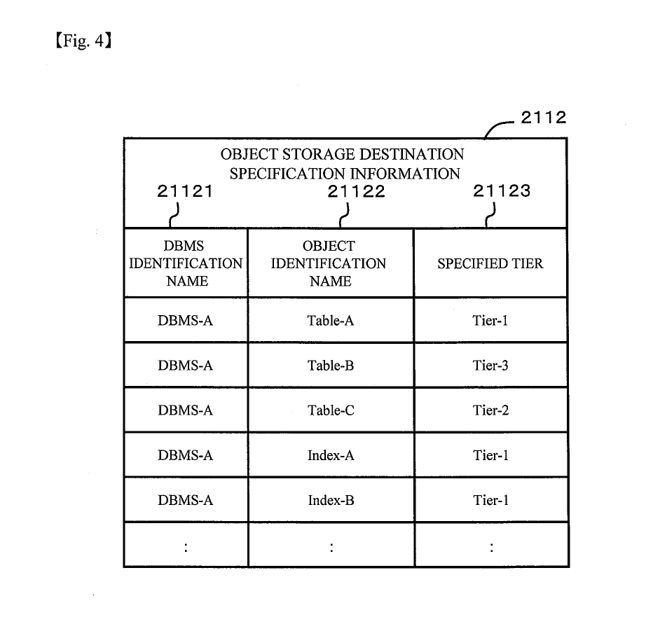

FIG. 4 is an arrangement example of the object storage destination specification information 2112 used by the object tier management program 2111. The object storage destination specification information 2112 is an example of “specific specification information.”

The object storage destination specification information 2112 is used for specifying the tier 3521 to be a storage destination for each of the objects 44121 included in the DBMS 4412. For example, a storage destination of an object is input using the management terminal 10 by the administrator of the DBMS 4412. Alternatively, a storage destination of an object may be specified automatically or manually by another method.

The object storage destination specification information 2112 includes a DBMS identification name 21121, an object identification name 21122, and a specified tier 21123, as the attribute, and holds information in the object 44121 unit in the DBMS 4412.

The DBMS identification name 21121 holds an identification name for uniquely identifying the DBMS 4412. The object identification name 21122 holds an identification name for uniquely identifying the object 44121 in the DBMS 4412. In the first embodiment, a table and an index are examples of an object. The specified tier 21123 holds an identification name for uniquely identifying the tier 3521 in which data of an object is to be stored. When a storage destination is an object that is not specified, an identification code indicating that there is no specified tier is configured in the specified tier 21123.

In the object storage destination specification information 2112, information related to the whole object 44121 in the DBMS 4412 is not necessarily registered. For an unregistered object 44121, information indicating that there is no specified tier may be configured, and a tier as an initial value may be prepared beforehand to configure the initial value.

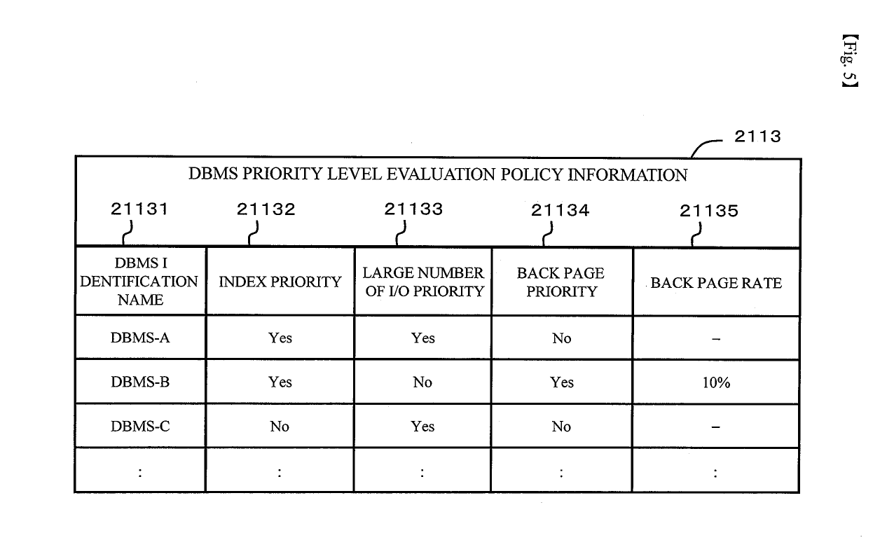

FIG. 5 is an arrangement example of the DBMS priority level evaluation policy information 2113 used by the object tier management program 2111. The DBMS priority level evaluation policy information 2113 is an example of “priority level management information.” The DBMS priority level evaluation policy information 2113 defines a policy for determining the priority level of an object. The DBMS priority level evaluation policy information 2113 is used when a priority level of page relocation is determined. For example, when the contents of the DBMS priority level evaluation policy information 2113 is input using the management terminal 10 by the administrator using the DBMS 4412, the contents may be input by another method.

The DBMS priority level evaluation policy information 2113 includes a DBMS identification name 21131, index priority 21132, the large number of I/Os priority 21133, back page priority 21134, and back page rate 21135, as the attribute. The DBMS priority level evaluation policy information 2113 holds information in the DBMS 4412 unit.

The DBMS identification name 21131 holds an identification name for uniquely identifying the DBMS 4412. The index priority 21132 holds information for identifying whether or not that the type of the object 44121 is an index is used as a criterion of priority level evaluation. When “Yes” is configured in the index priority 21132, the priority level of an object of type “index” is higher than that of an object of type “table.” When “No” is configured in the index priority 21132, there is no difference of priority levels by the types of objects. In such case, the priority levels of the indexes are equal and the priority levels of objects are equal.

The large number of I/O priority 21133 holds information for identifying whether or not the number of I/Os of an object is used as criterion of the priority level evaluation. When “Yes” is configured to the large number of I/O priority 21133, an object including the large number of I/Os has a higher priority level than that of an object including the small number of I/Os. When “No” is configured to the large number of I/O priority 21133, the priority level of an object does not change depending on the number of I/Os. The priority level of the object including the large number of I/Os is equal to the priority level of the object including the small number of I/Os.

The back page priority 21134 holds information for identifying whether or not high priority is given to back pages of pages used by an object in the priority level evaluation. When an object includes two or more pages, a page address (for example, a page number) is used for giving a higher priority level to back pages than that of another page. When “Yes” is configured in the back page priority 21134, a priority level of a specific back page of two or more pages included in an object is configured to be higher than that of another page. When “No” is configured in the back page priority 21134, there is no difference between priority levels of pages included in an object.

In the back page rate 21135, a valid value in a case in which the value of the back page priority 21134 is “Yes” is configured. The back page rate 21135 indicates what percentage of pages from the end of data of an object is regarded as the “back pages.”

For example, a case is described in which one object includes data of 10 pages portion in total ranging from a first page to a 10th page, “Yes” is configured in the back page priority 21134, and “10%” is configured in the back page rate 21135. In this case, data of 10% portion from the end of the data of the object corresponds to the 10th page that is a last page. Thus, the priority level of the 10th page that corresponds to the last 10% of the data of 10 pages in total in an identical object is higher than that of the first page to the ninth page.

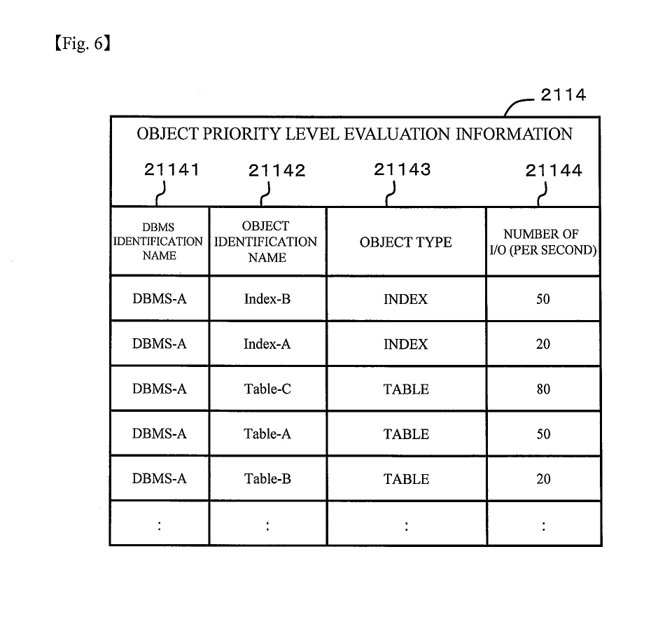

FIG. 6 is an arrangement example of the object priority level evaluation information 2114 used by the object tier management program 2111. Information for evaluating the priority level of an object is managed.

The object priority level evaluation information 2114 includes a DBMS identification name 21141, an object identification name 21142, an object type 21143, and the number of I/Os 21144, as the attribute, and holds information in an object unit in the DBMS 4412.

The DBMS identification name 21141 holds an identification name for uniquely identifying the DBMS 4412. The object identification name 21142 holds an identification name for uniquely identifying an object in the DBMS 4412. The object type 21143 holds the type of an object. The number of I/Os 21144 holds the number of I/Os of an object. The number of I/Os 21144 stores, for example, the average number of I/Os per unit time.

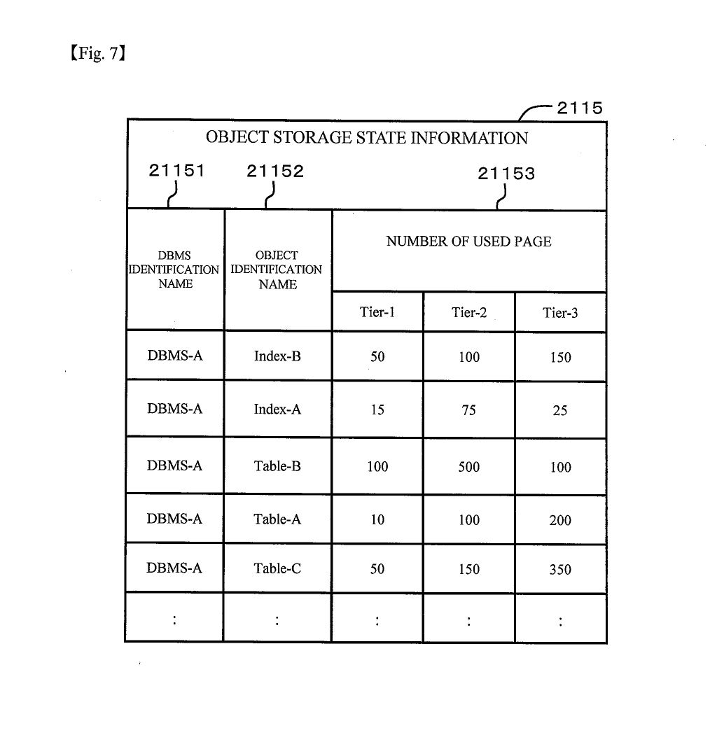

FIG. 7 is an arrangement example of the object storage state information 2115 used by the object tier management program 2111. The object storage state information 2115 manages a tier storing a page of an object and an amount of the page.

The object storage state information 2115 includes a DBMS identification name 21151, an object identification name 21152, and the number of used pages 21153, as the attribute, and holds information in an object unit in the DBMS 4412.

The DBMS identification name 21151 holds an identification name for uniquely identifying the DBMS 4412. The object identification name 21152 holds an identification name for uniquely identifying an object in the DBMS 4412. The number of used pages 21153 is the number of storages obtained by counting the page 3511 corresponding to the logical block 45111 used by an object for each of the tiers 3521. For example, for data of “Index-B” that is an object of “DBMS-A,” 50 pages are stored in “Tier-1,” 100 pages are stored in “Tier-2,” and 150 pages are stored in “Tier-3.”

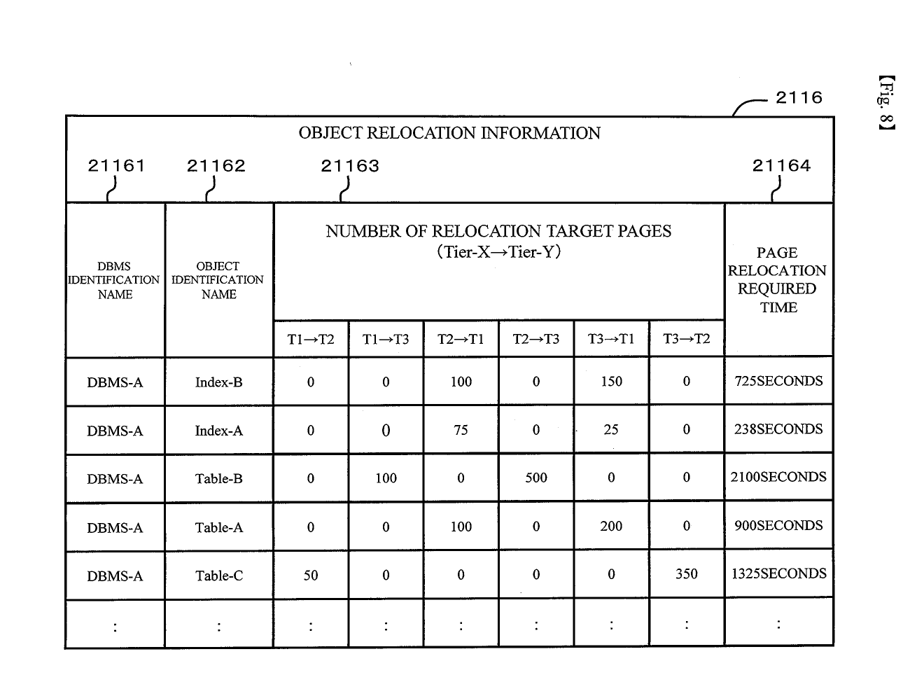

FIG. 8 is an arrangement example of the object relocation information 2116 used by the object tier management program 2111. The object relocation information 2116 is information for managing relocation of each page included in an object.

The object relocation information 2116 includes a DBMS identification name 21161, an object identification name 21162, the number of relocation target pages 21163, and a page relocation required time 21164, as the attribute, and holds information in an object unit in the DBMS 4412.

The DBMS identification name 21161 holds an identification name for uniquely identifying the DBMS 4412. The object identification name 21162 holds an identification name for uniquely identifying an object in the DBMS 4412. The number of relocation target pages 21163 holds the number of pages that is a target of the relocation process, of two or more pages included in an object for each combination pattern of a source tier and a destination tier. The page relocation required time 21164 holds a time required for the relocation of a page that is a relocation target.

For example, when a page is comprised in an object “Index-B” of “DBMS-A” is focused on, it is scheduled that 100 pages are transferred from “Tier-2” to “Tier-1,” 150 pages are transferred from “Tier-3” to “Tier-1.” All pages of “Index-B” may be stored in “Tier-1” that is an upper tier when the page relocation is completed as the object relocation information 2116 illustrated in FIG. 8, in comparison to the contents of the object storage state information 2115 in FIG. 7.

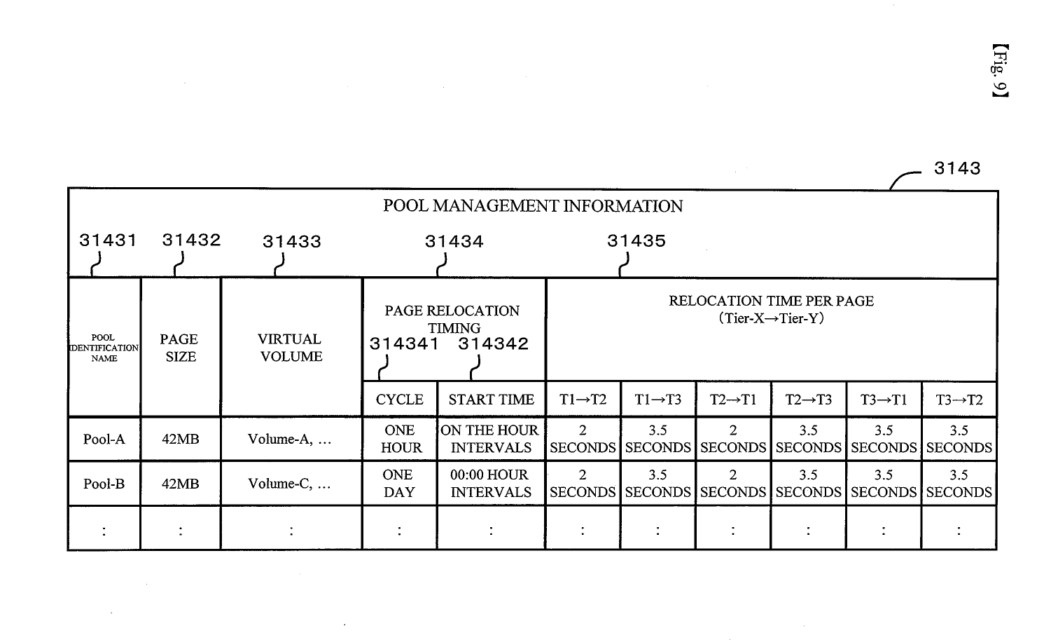

FIG. 9 is an arrangement example of the pool management information 3143 used by the page-based tier management program 3142. The pool management information 3143 is information for managing the pool 352 with respect to the page relocation.

The pool management information 3143 includes a pool identification name 31431, a page size 31432, a virtual volume 31433, the page relocation timing 31434, and a relocation time per page 31435, as the attribute, and holds information in the pool 352 unit in the storage 30.

The pool identification name 31431 holds an identification name for uniquely identifying the pool 352 in the storage 30. The page size 31432 holds a data size per page. A value unique to the storage 30 may be applied to the page size 31432, and the page size 31432 may be determined when the pool 352 is created. In the first embodiment, a value of the page size 31432 may be used when an address of the logical block 45111 is converted into a page address of the page 3511.

The virtual volume 31433 holds an identification name for uniquely identifying the virtual volume 351 using the pool 352. Two or more virtual volumes 351 may be provided to the one pool 352.

The page relocation timing 31434 holds information indicating a cycle 314341 and a start time 314342 on which the page relocation is performed for the pool 352 identified by the pool identification name 31431. In the first embodiment, it is assumed that the page relocation is periodically performed by the page-based tier management program 3142. The execution cycle 314341 may be customized for each pool, and is configured, for example, by the administrator of the storage 30.

The relocation time per page 31435 holds a time required for a relocation process per page. The pool management information 3143 according to the first embodiment may hold a different value for each combination pattern of a source tier and destination tier in the relocation time per page 31435 because a data read write speed is different for each of the tiers 3521. A total time required for the relocation process may be further precisely estimated by managing the relocation time per page for each of the combination patterns of the source tier and destination tier.

The relocation time per page 31435 may be an actually measured value, a value determined based on a past actual value of, and a value estimated from the performance of the disk drive 321. When a value of a page relocation time per page 31435 is calculated based on not an actually measured value but the performance of the disk drive 321, it is desirable to consider the impact, etc. on a normal I/O from the host 40. The storage 30 is desired to migrate a page between the tiers while processing a regular I/O request from the host 40. Thus, it is desirable to calculate the relocation time 31435 based on a resource amount available for the page relocation process other than a resource amount required for the regular I/O process. The resource amount required for the regular I/O process depends on the specification of the storage 30. It is noted that the resource amount is a microprocessor usage rate, a cache memory usage rate, etc.

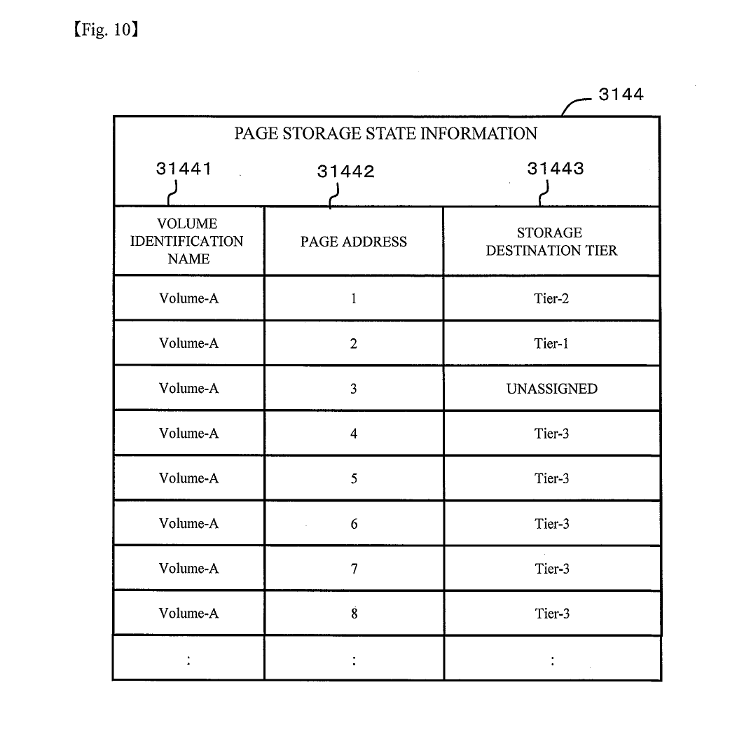

FIG. 10 is an arrangement example of the page storage state information 3144 used by the page-based tier management program 3142. The page storage state information 3144 is information for managing a storage destination tier of the physical page 35211 corresponding to the virtual page 3511 in the virtual volume 351. The page storage state information 3144 is updated in the new assignment of a page, in the page relocation, and in the page release.

The page storage state information 3144 includes a volume identification name 31441, a page address 31442, and a storage destination tier 31443, as the attribute, and holds information in the page 3511 unit in the virtual volume 351 in the storage 30.

The volume identification name 31441 holds an identification name for uniquely identifying the virtual volume 351 in the storage 30. The page address 31442 holds an identification name for uniquely identifying the virtual page 3511 in the virtual volume 351. The storage destination tier 31443 holds an identification name for uniquely identifying a storage destination tier 3521 of a physical page 35211 storing data of the virtual page 3511 in the virtual volume 351. In the virtual page 3511 in which a physical page is not allocated, an identification name indicating “unassigned” is stored in the storage destination tier 31443. In the following description, the physical page 35211 storing data of the virtual page 3511 may be referred to as a physical page corresponding to a virtual page.

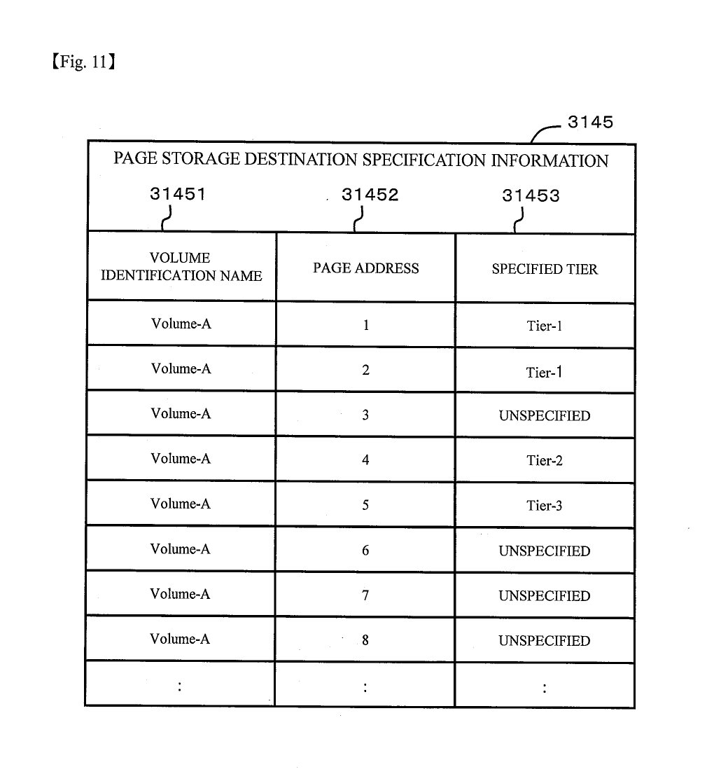

FIG. 11 is an arrangement example of the page storage destination specification information 3145 used by the page-based tier management program 3142. The page storage destination specification information 3145 manages the tier 3521 to which the physical page 35211 storing the data of a virtual page of the virtual volume 351 is to be provided. The page storage destination specification information 3145 includes a volume identification name 31451, a page address 31452, a specified tier 31453, as the attribute, and holds information in the page 3511 unit in the virtual volume 351 in the storage 30.

The volume identification name 31451 holds an identification name for uniquely identifying the virtual volume 351 in the storage 30. The page address 31452 holds an identification name for uniquely identifying the virtual page 3511 in the virtual volume 351. The specified tier 31453 holds an identification name for uniquely identifying the tier 3521 in which the physical page 35211 corresponding to a virtual page 351 is to be stored. When a storage destination is not specified, an identification name indicating “unspecified” is stored in the specified tier 31453.

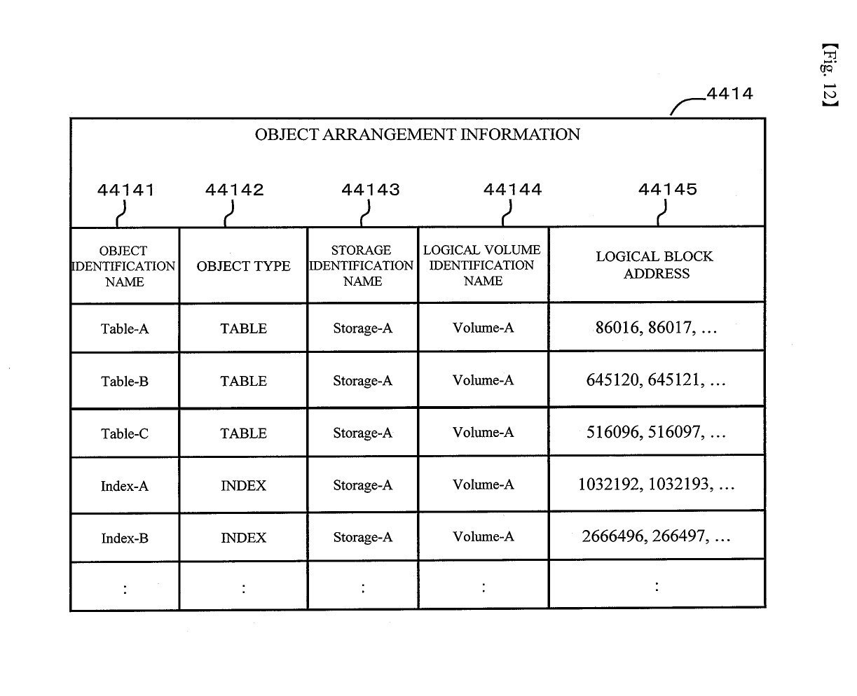

FIG. 12 is an arrangement example of the object arrangement information 4414 used by the DBMS data collection program 4411. The object arrangement information 4414 manages the arrangement of an object. The object arrangement information 4414 is created, for example, by obtaining desired information from the DBMS 4412 in response to a request from the object tier management program 2111.

The object arrangement information 4414 includes an object identification name 44141, an object type 44142, a storage identification name 44143, a logical volume identification name 44144, and a logical block address 44145, as the attribute, and holds information in an object unit in the DBMS 4412.

The object identification name 44141 holds an identification name for uniquely identifying an object. The object type 44142 holds a value indicating the type of an object. The storage identification name 44143 holds an identification name for uniquely identifying the storage 30 providing the logical volume 451 storing the data of an object. The logical volume identification name 44144 holds an identification name for uniquely identifying the logical volume 451 storing the data of an object. The logical block address 44145 holds the specific number of identification codes for uniquely identifying the logical block 45111 on the logical volume 451 storing the data of an object.

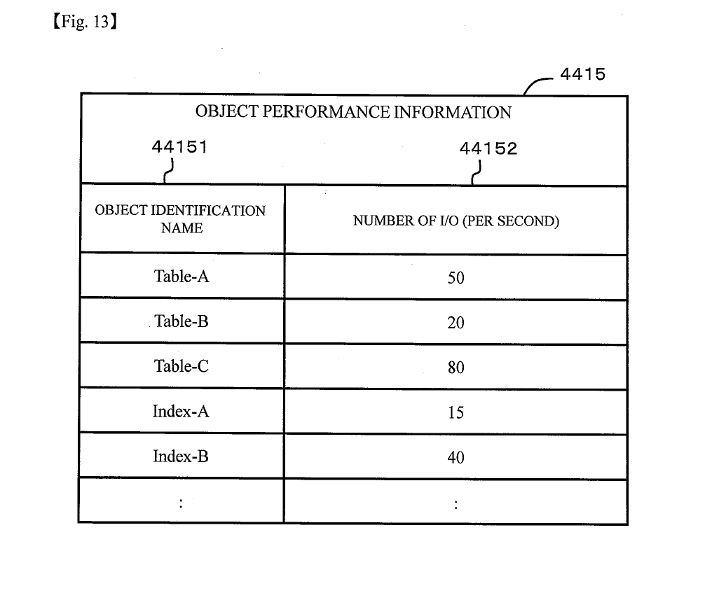

FIG. 13 is an arrangement example of the object performance information 4415 used by the DBMS data collection program 4411. The object performance information 4415 is created by, for example, obtaining desired information from the DBMS 4412 in response to a request from the object tier management program 2111.

The object performance information 4415 includes an object identification name 44151 and the number of I/Os 44152, as the attribute, and holds information in an object unit in the DBMS 4412. The object identification name 44151 holds an identification name for uniquely identifying an object. The number of I/Os 44152 holds a value indicating the number of I/Os of an object.

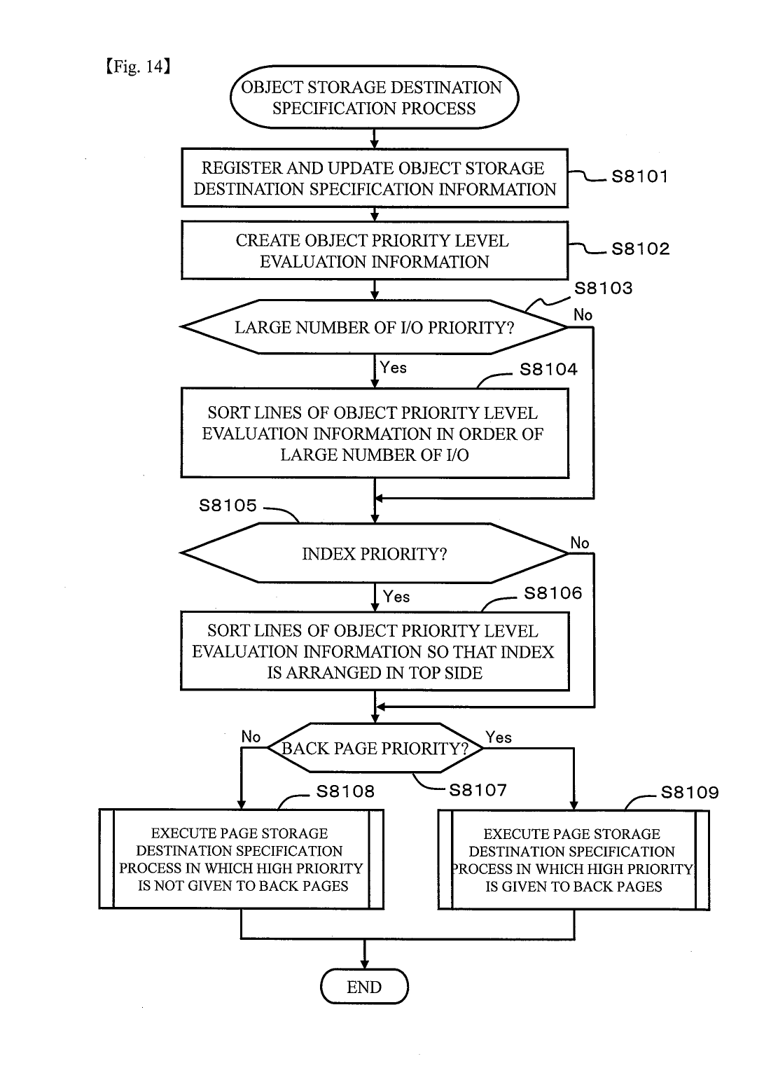

FIG. 14 is a flowchart indicating a process for identifying the storage destination of an object. A part of the process or the whole process is an example of a “priority level determination step.” In the object-based tier management system, information for indicating a tier to which an object is to be allocated is configured by a specific method.

An allocation destination tier (storage destination tier) on which configuration for an object is performed is configured to all pages used by the object. FIG. 14 illustrates a series of the processes. The all processes in FIG. 14 are executed by the object tier management program 2111.

The object tier management program 2111 may refer to the object arrangement information 4414 and the object performance information 4415 through the DBMS data collection program 4411, as appropriate. In addition, the object tier management program 2111 may refer to the pool management information 3143, the page storage state information 3144, and the page storage destination specification information 3145 through the page-based tier management program 3142, as appropriate.

An operation in FIG. 14 is described. The object tier management program 2111 may be referred to as a management program 2111 below.

The management program 2111 prepares the object storage destination specification information 2112 (S8101). As described above, the tier 3521 that is to be an allocation destination of an object in the DBMS 4412 is configured to the object storage destination specification information 2112 by the specific method. For example, a storage destination of an object is allowed to be registered to the object storage destination specification information 2112 by accessing the object tier management program 2111 through the management terminal 10 by the administrator of the DBMS 4412.

After that, the management program 2111 prepares the object priority level evaluation information 2114 (S8102). As described below, the object priority level evaluation information 2114 may be created, for example, based on the object arrangement information 4414 and the object performance information 4415.

That is, the object identification name 44141 of the object arrangement information 4414 and the contents of the object type 44142 are stored to the object identification name 21142 and the object type 21143 of the object priority level evaluation information 2114, respectively. After that, the number of I/Os 44152 of the object performance information 4415 is stored to the number of I/Os 21144 of the object priority level evaluation information 2114. In the DBMS identification name 21141 of the object priority level evaluation information 2114, the identification name may be stored in the DBMS 4412.

When the number of I/Os for each of the pages 3511 is measured in the storage 30, the number of I/Os for each object may be calculated using the number of I/Os for each of the pages 3511. That is, the logical block 45111 used by an object is allowed to be identified by referring to the object arrangement information 4414, and in addition, the page 3511 used by the logical block 45111 is allowed to be identified by the method described in FIG. 2. The number of I/Os of an object is allowed to be obtained by acquiring the number of I/Os of each of the pages 3511 used by the object from the storage 30 and counting the number. When the method is used, the object performance information 4415 may be omitted.

The management program 2111 determines whether or not the priority level of page relocation is changed based on the size of the number of I/Os (S8103). It is desirable that the relocation is performed as promptly as possible because a page including the large number of I/Os has a large influence on I/O performance. As described in FIG. 5, in the first embodiment, the way is provided in which high priority is given to the relocation of a page including the large number of I/Os.

Step S8103 is described in detail. The management program 2111 refers to a value of the large number of I/O priority 21133 in a line related to a DBMS that is a processing target of the DBMS priority level evaluation policy information 2113. The flow proceeds to step S8104 when the value is “Yes,” and the flow proceeds to step S8105 when the value is “No.” The DBMS priority level evaluation policy information 2113 is prepared using a specific means. For example, the value is allowed to be registered to the DBMS priority level evaluation policy information 2113 by accessing the object tier management program 2111 through the management terminal 10 by the administrator of the DBMS 4412.

When the large number of I/O priority is selected (S8103: YES), the management program 2111 sorts the lines of the object priority level evaluation information 2114 using the value of the number of I/Os 21144 as a key, in descending order (S8104). As a result, the object 44121 included in the DBMS 4412 to be processed is sorted in descending order of the number of I/Os.

The management program 2111 determines whether or not high priority is given to an object having an object type “index” (S8105). Generally, an index is often referred to. Thus, an index that is an arrangement element of a DBMS has a large influence on I/O performance because the index includes the large number of I/Os. As described in FIG. 5, in the first embodiment, the priority level of the index is configured to be allowed to be higher than the priority level of a table because it is desirable that the index is relocated as promptly as possible.

The management program 2111 refers to a value of the high index priority 21132 in a line related to a DBMS that is a processing target, of the DBMS priority level evaluation policy information 2113. The flow proceeds to step S8106 when the value is “Yes,” and the flow proceeds to step S8107 when the value is “No.”

Step S8106 is a process in a case in which high priority is given to an object having an object type “index.” The management program 2111 sorts the lines of the object priority level evaluation information 2114 so that a line including the value of an index is allocated in the top side using the value of the object type 21143 as a key.

Step S8107 is a process for determining whether or not high priority is given to back pages. For example, a case is considered in which data is registered to the table of a DBMS in a write-once manner. In this case, new data is stored about the rear part of the data. Thus, access to a page in the rear part of the object is relatively large. It is desirable that the relocation is performed as promptly as possible because the page having large access has a large influence on the I/O performance.

In the first embodiment, a way is provided in which high priority is given to the relocation for back pages. Specifically, the management program 2111 determines the priority by referring to a value of the back page priority 2113 in a line related to a DBMS that is a processing target, of the DBMS priority level evaluation policy information 2113 (step S8107). The flow proceeds to step S8109 when the value of the back page priority 21134 is “Yes,” and the flow proceeds to step S8108 when the value is “No.”

When high priority is given to back pages (S8107: Yes), the management program 2111 executes a page storage destination specification process in which high priority is given to the back pages (S8109). When high priority is not given to the back pages (S8107: No), the management program 2111 executes the page storage destination specification process in which high priority is not given to back pages (S8108).

When a process in step S8108 or step S8109 is completed, an object storage destination specification process ends.

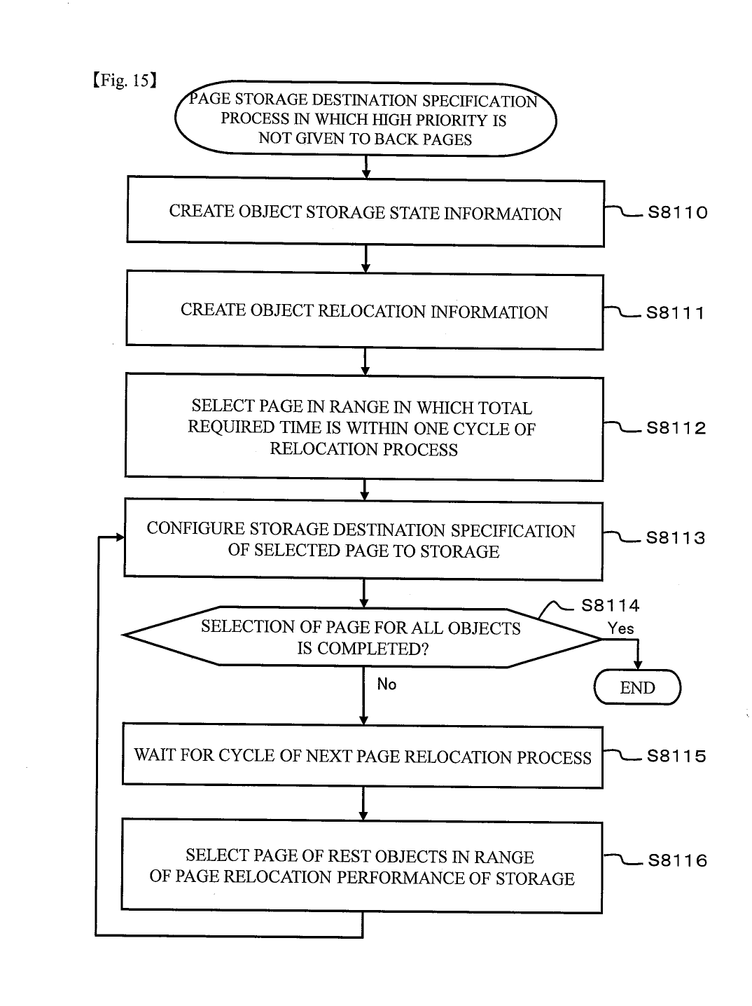

FIG. 15 is a flowchart illustrating the detailed process (S8108 in FIG. 14) for identifying a page storage destination without giving high priority to back pages. The process is also executed by the object tier management program 2111.

Step S8110 is a process for creating the object storage state information 2115. The object storage state information 2115 may be created, for example, based on the object arrangement information 4414 and the page storage state information 3144.

The LBA of a logical block 4511 used by an object is allowed to be identified by referring to the logical block address 44145 of object arrangement information 4414. The page address of the page 3511 corresponding to the logical block 4511 is allowed to be calculated by the method described in FIG. 2. Which tier 3521 stores the data of a specific page address, is allowed to be identified by referring to the storage destination tier 31443 of the page storage state information 3144. Thus, the storage destination tier of a page used by an object is allowed to be identified, and in addition, the number of pages used by an object is allowed to be counted for each of the tiers.

Step S8111 is a process for creating the object relocation information 2116 that is an example of a “relocation information generation step.” The object relocation information 2116 is allowed to be created, for example, based on the object storage destination specification information 2112 and the object storage state information 2115.

As illustrated in FIG. 8, the number of relocation target pages 21163 of the object relocation information 2116 holds the number of relocation target pages for each combination pattern of a source tier and a destination tier. The number of relocation target pages 21163 is allowed to be calculated based on the specified tier 21123 of the object storage destination specification information 2112 and the number of used pages 21153 of the object storage state information 2115.

For example, when the line in which a value of the object identification name 21122 of the object storage destination specification information 2112 is “Table-A” is focused on, a value of the specified tier 21123 is “Tier-1.” Therefore, it is indicated that the object “Table-A” is allocated to the tier “Tier-1.”

On the other hand, when the line in which a value of the object identification name 21152 of the object storage state information 2115 is “Table-A” is focused on, the number of pages used in “Tier-1” that is the upper tier is “10,” the number of pages used in “Tier-2” that is the middle tier is “100,” and the number of pages used in “Tier-3” that is the lower tier is “200.”

It is specified that the page of the object “Table-A” is allocated to the upper tier “Tier-1” by the object storage destination specification information 2112. Thus, it is found that a page belonging to the middle tier “Tier-2” is to be relocated to the upper tier “Tier-1” by 100 pages, and a page belonging to the lower tier “Tier-3”is to be relocated to the upper tier “Tier-1” by 200 pages.

Thus, as described below, the management program 2111 configures a value to the number of relocation target pages 21163 for “Table-A” in the object relocation information 2116 illustrated in FIG. 8. That is, the management program 2111 stores “100” in an area “T2 to T1” and “200” in an area “T3 to T1,” respectively.

In the page relocation required time 21164 of the object relocation information 2116, a time required for the page relocation related to the object is held. The required time may be calculated, for example, based on “the number of relocation target pages 21163” of the object relocation information 2116 and “relocation time per page 31435” of the pool management information 3143.

Using an object having the identification name “Table-A” as an example, a method for obtaining a relocation required time is described. In the object relocation information 2116, when a value of the number of relocation target pages 21163 in the line of “Table-A” is focused on, “T2 to T1” is “100,” and “T3 to T1” is “200.” That is, it is indicated that migration is performed from the middle tier to the upper tier by 100 pages, and migration is performed from the lower tier to the upper tier by 200 pages.

Next, in each of “T2 to T1” and “T3 to T1,” a relocation required time per page is allowed to be calculated by the method described below.

That is, it is found that a virtual volume “Volume-A” is used for the object “Table-A” by referring to the value of the logical volume identification name 44144 of the object arrangement information 4414. In addition, it is found that the virtual volume “Volume-A” belongs to a pool “Pool-A” by referring to the value of virtual volume 31433 of the pool management information 3143. When values of “T2 to T1” and “T3 to T1” of the relocation time per page 31435 in an identical line are referred to, the required times “2 seconds” and “3.5 seconds” are derived.

The required times are obtained by multiplying the number of relocation target pages by relocation required time per page. Thus, “T2 to T1” is 200 seconds, and “T3 to T1” is 700 seconds, so that the total is 900 seconds. The value (900 seconds) is the value of the page relocation required time 21164 in the line of “Table-A” of the object relocation information 2116.

It is noted that the order of the lines of the object relocation information 2116 is sorted so as to be the similar to the order of the line of the object priority level evaluation information 2114.

Step S8112 is a process for selecting a page that is a relocation target by the number of pages in which the relocation is allowed to be performed in the cycle of the page relocation. Step S8112 is an example of a “selection step.” It is noted that S8116, S8122, S8126, S8129, S8133, S8305, and S8309 described later are also examples of the “selection step.” The page relocation cycle is a cycle for executing the page relocation process and is obtained from the cycle 314341 of the pool management information 3143.

As illustrated in FIG. 9, for example, when the DBMS 4412 that is processing target uses the virtual volume “Volume-A,” the page relocation cycle is “one hour.” In the pool “Pool-A” to which the virtual volume “Volume-A” belongs to, the page relocation process is executed every hour.

The management program 2111 selects a page that is a relocation target by the number of pages corresponding to the cycle of the page relocation from the top of the object relocation information 2116. For example, when the cycle is one hour, relocation target pages are selected until 3600 seconds in total from the top line is counted.

As described below, it is noted that the number of pages defined by the cycle of the page relocation process may be called the number of upper limit pages. The number of upper limit pages is dependent on the page relocation performance of the storage 30 because the number of upper limit pages is the number of pages in which the relocation is allowed to be performed for one cycle of the page relocation process. When the cycle is identical and the page relocation performance is high, the number of upper limit pages increases. Thus, it may be expressed that the number of upper limit pages is a value defined by the performance of the relocation process of a page.

In the example of FIG. 8, all pages included in objects “Index-B,” “Index-A,” and “Table-B,” and some pages of object “Table-A” are selected as a relocation target page.

Step S8113 that is an example of an “instruction step” is a process for configuring the storage destination specification of a selected page to the storage 30. The management program 2111 configures the storage destination tier of each of the selected pages to the page storage destination specification information 3145 through the page-based tier management program 3142 in step S8112, or step S8116 described later. It is noted that S8123, S8130, and S8306 described later are also examples of the “instruction step.”

The management program 2111 determines whether or not the selection of the relocation target page for all objects that are processing targets is completed (S8114). When the relocation target page for all objects that are processing targets is selected and the selected contents are configured to the storage 30 (S8114: Yes), the process ends.

When an object that is not processed remains (S8114: No), that is, an unprocessed page remains, the management program 2111 waits for the cycle of next page relocation process (S8115).

The management program 2111 waits for a page relocation cycle subsequent to the page relocation cycle of the processing target executed just before in step S8113. The page relocation corresponding to the contents configured to the storage 30 in step S8113 is processed within one cycle by the waiting process. For example, when the relocation cycle is one hour, the management program 2111 waits by one hour. The relocation of the previously selected page is completed during the waiting time.

Step S8116 is a process for selecting a page that is a relocation target and similar to the process of step S8112. A difference between step S8112 and step S8116 is described. In step S8112, a page indicated in the top line of the object relocation information 2116 is selected in order. On the other hand, in step S8116, an unprocessed page that is not processed for the storage 30 is selected in order.

For example, in the above-described example, in step S8112, all pages included in the object “Index-B,” “Index-A,” and “Table-B” and some pages of the object “Table-A” are selected as a relocation target page. Thus, in step S8116, the rest pages of the object “Table-A” and all pages of the object “Table-C” are selected as a relocation target page.

It is noted that, in the example of FIG. 15, in step S8113, the case is described in which a relocation target page is configured to the storage 30 for each cycle of the page relocation process. Alternatively, another method may be employed. For example, when the page-based tier management program 3142 includes a function for performing the page relocation in order of configuration of the object tier management program 2111, all relocation target pages are selected in step S8112, and the process may end immediately after executing step S8113.

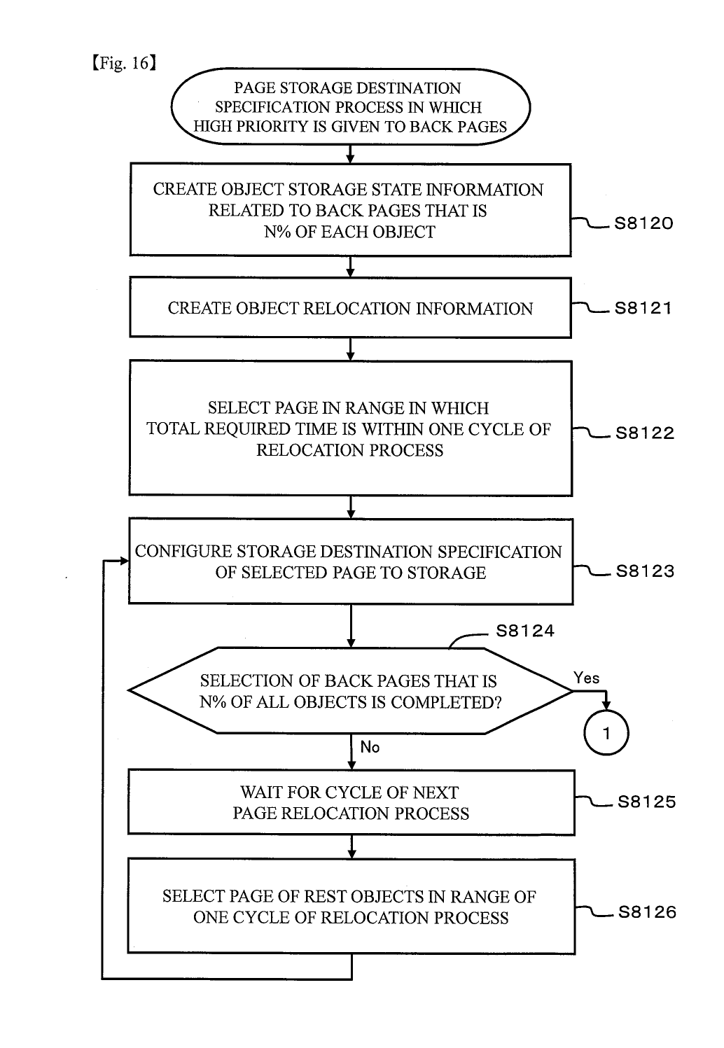

FIG. 16 is a flowchart of the detailed process (S8109 in FIG. 14) for specifying a page storage destination by giving high priority to back pages. The process is also executed by the object tier management program 2111.

In the process for specifying a page storage destination by giving high priority to back pages, processing for front pages (page other than the back pages) of each object is performed after processing for back pages of each of the objects is performed. A difference between the process contents of FIGS. 15 and 16 is mainly described because the process contents of FIG. 16 is similar to the process contents of FIG. 15.

Step S8120 is a process for creating the object storage state information 2115 similar to step S8110 in FIG. 15. In step S8110, the all pages of all objects are processing targets. On the other hand, in step S8120, mere back pages of each of the objects are processing targets.

Back pages that are a target is allowed to be identified by referring to the value of the back page rate 21135 of the DBMS priority level evaluation policy information 2113. For example, in the example of FIG. 5, the value of the back page rate 21135 of the line in which the value of the DBMS identification name 21131 is “DBMS-B” is configured to “10%.” Thus, the page of 10% from the end of each of the objects of “DBMS-B” is regarded as back pages. The other pages other than the back pages are called, for convenience, front pages. As described above, the ranges of back pages and front pages are relatively defined by a specified specific value (back page rate).

Step S8121 is substantially the same as step S8111 in FIG. 15.

Step S8122 is substantially the same as step S8112 in FIG. 15. In step S8112, a page in which the storage 30 is specified as a storage destination is selected from all relocation target pages of each object. On the other hand, in step S8122, a page in which the storage 30 is specified as a storage destination is selected from back pages of relocation target pages of each object.

Step S8123 is substantially the same as step S8113 in FIG. 15.

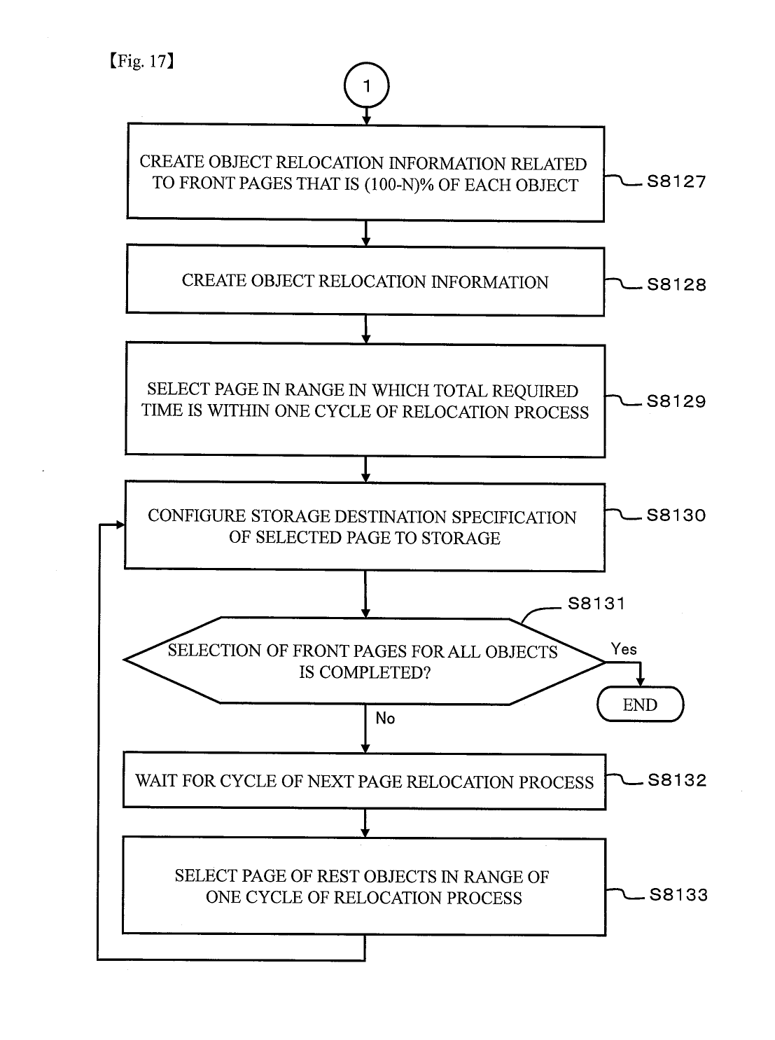

Step S8124 is substantially the same termination determination operation as step S8114 in FIG. 15. In step S8114, it is determined whether or not a selection process for all relocation target pages of each object is completed. On the other hand, in step S8124, it is determined whether or not a process for all back pages of relocation target pages of each of the objects is completed. In addition, in step S8124, the flow proceeds to step S8127 described later in FIG. 17 when the selection process for the all back pages is completed, as compared with step S8114.

Step S8125 is substantially the same as step S8115 in FIG. 15.

Step S8126 is substantially the same as step S8116 in FIG. 15. In step S8116, pages of the rest objects are selected from all allocation target pages. On the other hand, in step S8126, pages of the rest objects are selected from back pages of each of the objects.

Description is made with reference to FIG. 17. Step S8127 is substantially similar to step S8112 in FIG. 15. In step S8112, a page in which the relocation is specified to the storage 30 is selected from all relocation target pages of each of the objects. On the other hand, in step S8127, a page in which storage 30 is specified is selected from front pages of each object. The front pages are pages other than the back pages. That is, when pages storing the no data from the end of the data of an object are back pages, front pages are pages storing the (100−n)% data that are rest portions.

Step S8128 is substantially the same as step S8113 in FIG. 15.

Step S8129 is substantially the same as step S8112 in FIG. 15. In step S8112, a page in which the storage 30 is specified as a storage destination is selected from all relocation target pages of each of the objects. On the other hand, in step S8129, a page in which storage 30 is specified as a storage destination is selected from front pages of relocation target pages of each of the objects.

Step S8130 is substantially the same as step S8113 in FIG. 15.

Step S8131 is substantially the same termination determination operation as step S8114 in FIG. 15. In step S8114, it is determined whether or not a process for all pages of each of the objects is completed. On the other hand, in step S8131, it is determined whether or not a process for all front pages of relocation target pages of each of the objects is completed.

Step S8132 is substantially the same as step S8115 in FIG. 15.

Step S8133 is substantially the same as step S8116 in FIG. 15. In step S8116, pages of the rest objects are selected from all relocation target page of each of the objects. On the other hand, in step S8126, pages of the rest objects are selected from front pages of each of the objects.

As described above, the procedures described in FIGS. 14 to 17 are executed. As a result, a storage destination of each of the pages used by an object is allowed to be configured to the storage 30 in appropriate order according to a priority level based on arrangement and/or state, etc. of an object 4412.

It is noted that, in step S8112, S8116, S8122, S8126, S8129, and S8133 of FIG. 15, the case is described in which a page in which a storage destination is configured within one relocation cycle based on the time required for page relocation and a relocation cycle is selected. Alternatively, the range of a page in which a storage destination is configured within one relocation cycle may be selected based on the number of relocation target pages of each of the objects and the number of relocation pages of one relocation cycle.

For example, a method may be employed in which the number of upper limit pages is determined from an average time required for relocation per page and a time of a relocation cycle, and pages of an object having high priority level are selected in order until reaching the number of upper limit pages.

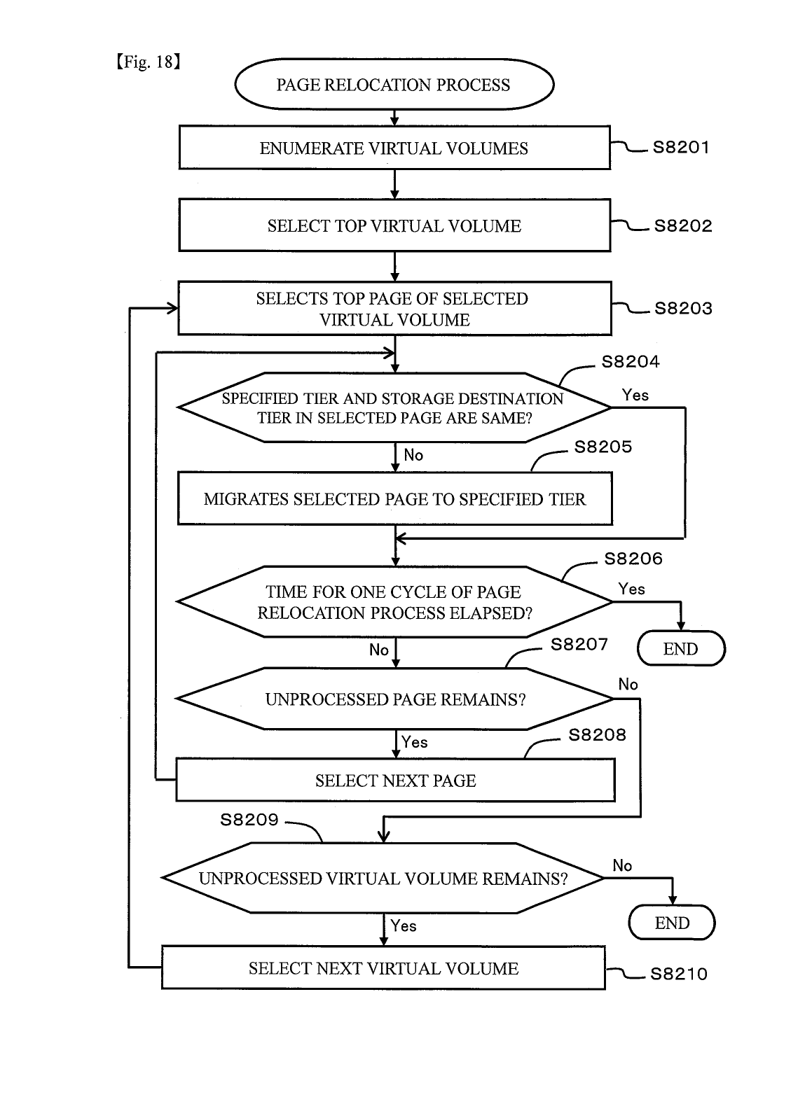

FIG. 18 is a flowchart of the page relocation process executed by the page-based tier management program 3142 in the storage 30. The page relocation process is executed according to the value defined by the page relocation timing 31434 of the pool management information 3143 for each of the pools 352. The specific processing contents are described below. The page-based tier management program 3142 may be referred to as the tier management program 3142 below.

Step S8201 is a process for enumerating the virtual volumes 351 belonging to the pool 352 of a processing target. The tier management program 3142 is allowed to extract all of the virtual volumes 351 belonging to the specific pool 352 by referring to the virtual volume 31433 of the pool management information 3143 (S8201).

The tier management program 3142 selects the top virtual volume 351 from the virtual volumes 351 enumerated in step S8201 (S8202).

The tier management program 3142 selects the top page 3511 from pages used by the virtual volume 351 selected in step S8202 (S8203).

The tier management program 3142 determines the necessity of relocation of the page 351 selected in step S8203 (S8204).

The tier management program 3142 identifies the storage destination tier 31443 of the selected page 351 by referring to the page storage state information 3144. After that, the tier management program 3142 identifies a tier 31453 specified as the storage destination of the selected page 351 by referring to the page storage destination specification information 3145. In addition, the tier management program 3142 compares the current storage destination tier 31443 of the selected page 351 and the tier 31453 specified as the storage destination of the selected page 351 (S8204).

When a current storage destination tier and a specified tier are different (S8204: No), it is determined that page relocation is desired, and the flow proceeds to step S8205. When a current storage destination tier and a specified tier are same (S8204: Yes), it is determined that page relocation is not desired, and the flow proceeds to step S8206. When “unspecified” is configured to the specified tier 31453 of a page storage destination specification 3145, it is determined that page relocation is not desired, and the flow proceeds to step S8206.

The tier management program 3142 migrates the data of the page selected in step S8203 to the tier 3521 identified in the specified tier 31453 (S8205). Specifically, the data is copied from a source page (physical page corresponding to a virtual page selected in S8203) belonging to a source tier (current storage destination tier) to a destination page (physical page) belonging to a destination tier (specified tier). In addition, the physical page corresponding to the virtual page is changed from the source page to the destination page.

The tier management program 3142 determines whether or not a time for one cycle of the page relocation process elapses after the start of the page relocation (S8206). The process ends when the time for one cycle of the page relocation process elapses (S8206: Yes), and the flow proceeds to step S8207 when the time for one cycle of the page relocation process does not elapse (S8206: No).

The tier management program 3142 determines whether or not the processing for all of the pages 3511 of the virtual volume 351 selected in step S8202 is completed (S8207). When the last page 3511 of the selected virtual volume 351 is selected and there is no subsequent page 3511 (S8207: No), the flow proceeds to step S8209.

When there is an unprocessed page (S8207: Yes), the tier management program 3142 selects the page 3511 (S8208), the flow returns to step S8204.

The tier management program 3142 determines whether or not the processing for all virtual volumes is completed (S8209). The process ends when the last virtual volume 351 of the virtual volumes 351 enumerated in step S8201 is being selected and there is no subsequent virtual volume 351 (S8209: No), and the flow proceeds to step S8210 when the last virtual volume 351 of the virtual volumes 351 enumerated in step S8201 is not being selected or there is a subsequent virtual volume 351.

The tier management program 3142 selects the unprocessed virtual volume 351 of the virtual volumes 351 enumerated in step S8201 (S8210), the flow returns to step S8203.

As described above, the page-based tier management program 3142 relocates pages based on the contents of the page storage destination specification information 3145 specified by the object tier management program 2111 by the process illustrated in FIG. 18.

Next, an example of an operation screen according to the first embodiment is described. A screen described below may be displayed when accessing the object tier management program 2111 using the management terminal 10 by the administrator, etc. of the DBMS 4412.

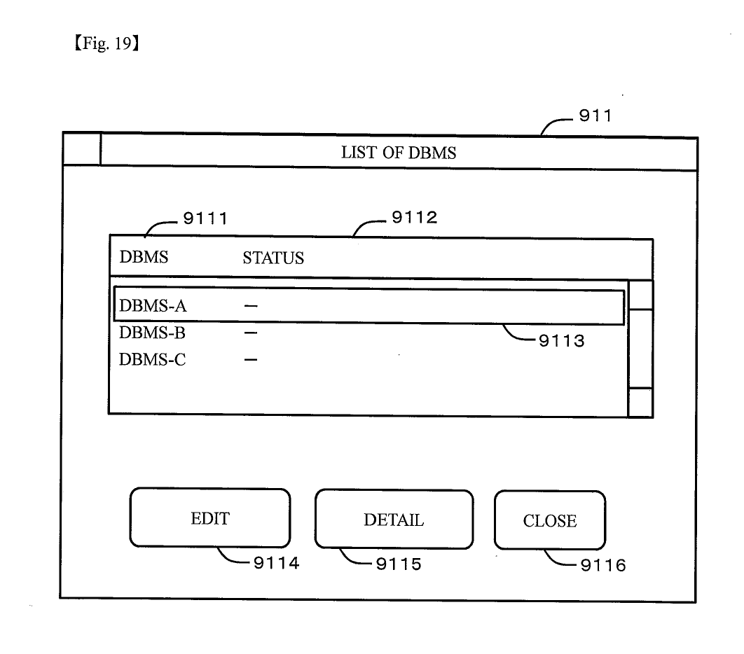

FIG. 19 is a screen 911 for displaying a list of DBMS. The screen 911 of DBMS list displays a list of the DBMS 4412 that is a management target of an object tier management program 2111.

A DBMS display area 9111 displays an identification name of the DBMS 4412 that is a management target. A status display area 9112 displays the progress of the page relocation process. When “-” is displayed, it is indicated that the page relocation process is not started.

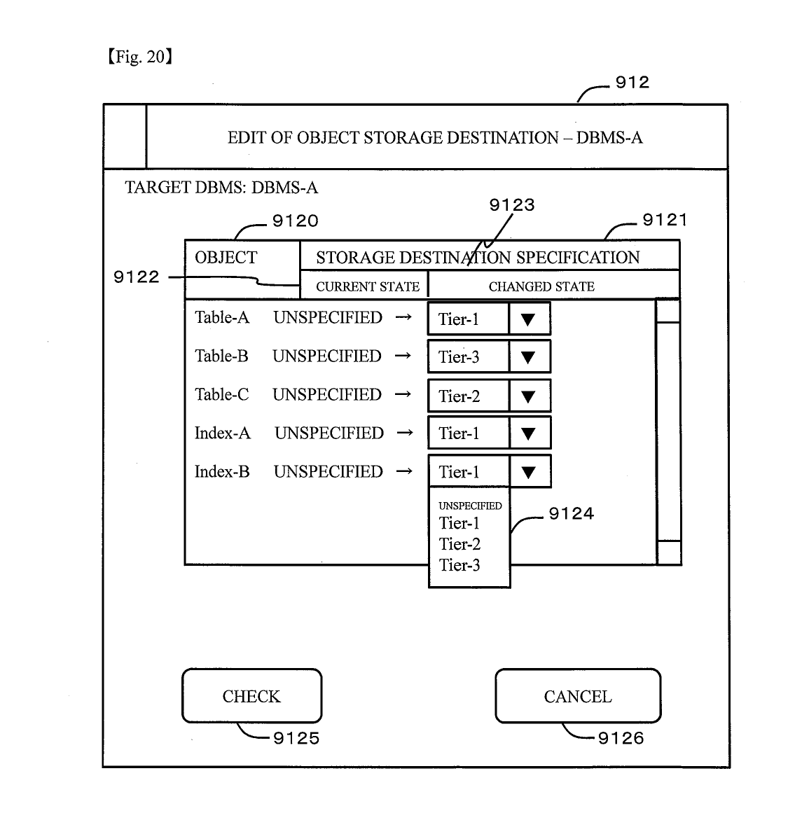

An edit button 9114 is a button for editing the specification of a storage destination. The edit button 9114 specifies the storage destination of a page of each object included in the selected DBMS 9113. When the button 9114 is pressed by the administrator, etc. of the DBMS 4412, a screen 912 of FIG. 20 is opened. The screen 912 may be opened as a new screen different from the screen 911, and the transition of screen is performed from the screen 911 to the screen 912. Another screen described below is similar to the screens.

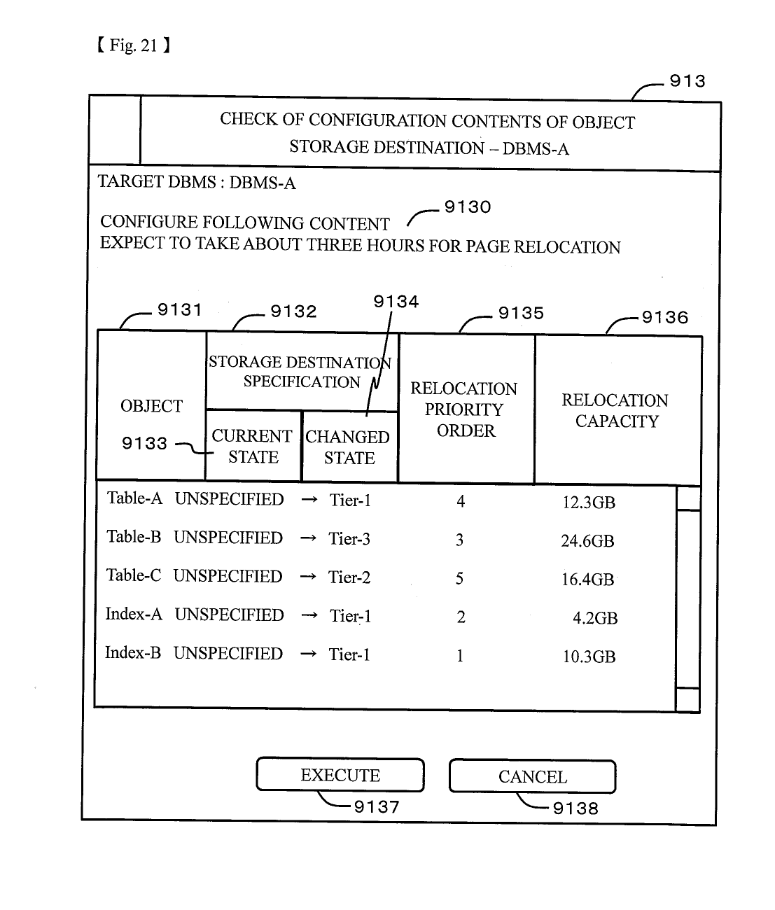

A detail button 9115 is a button for displaying the detailed information of a status of the page relocation process related to the selected DBMS 9113. When the button 9115 is pressed by the administrator, etc. of the DBMS 4412, a screen of FIG. 21 is opened.

A close button 9116 is a button for closing the screen 911 illustrated in FIG. 19.

FIG. 20 is a screen 912 for editing the storage destination of an object. The screen 912 for editing the storage destination of an object is used for specifying the storage destination tier of an object in the specific DBMS 4412.

An object display area 9120 displays the identification name of an object. A storage destination specification area 9121 is an area for specifying the storage destination of an object. The storage destination specification area 9121 includes a current state display area 9122 and a change option 9123.

The current state display area 9122 displays the contents of storage destination specification configured to the object displayed in the object display area 9120. When storage destination is not specified, “unspecified” is displayed.

The change option 9123 provides a function for specifying the storage destination of an object. The desired storage destination is allowed to be specified using the change option 9123 by the administrator, etc. of the DBMS 4412.

A check button 9125 is a button for fixing the contents selected in the change option 9123. When the check button 9125 is pressed by the administrator, etc. of the DBMS 4412, the screen proceeds to a screen in FIG. 21.

A cancel button 9126 is a button for canceling the contents selected in the change option 9123. When the cancel button 9126 is pressed by the administrator, etc. of the DBMS 4412, the screen in FIG. 20 is closed and the screen returns to the screen of FIG. 19.

FIG. 21 illustrates the screen 913 for checking the configuration contents of an object storage destination. The contents configured in the screen 912 illustrated in FIG. 20 are checked through the check screen 913 of the configuration contents by the administrator, etc. of the DBMS 4412.

A required time display area 9130 displays a time required for page relocation. For example, processes corresponding to step S8110 and step S8111 in FIG. 15 are executed, and the total value of the page relocation required time 21164 of the object relocation information 2116 may be displayed in the required time display area 9130.

An object display area 9131 displays the identification name of an object. The storage destination specification area 9132 displays the storage destination specification of an object. The storage destination specification area 9132 includes a current state display area 9133 and a changed state display area 9134.

The current state display area 9133 displays the contents of the storage destination specification configured to the object identified by the object display area 9131. When storage destination is not specified, “unspecified” is displayed. The changed state display area 9134 displays the contents configured in the change option 9123 of the screen 912 in FIG. 20.

A relocation priority order display area 9135 displays a priority level related to the page relocation of each object. In the display area 9135, numbers in order of the priority corresponding to the sequence of the lines of the object priority level evaluation information 2114 may be displayed.

A relocation capacity display area 9136 displays the relocation target capacity of each object. In the display area 9136, the capacity based on the number of relocation target pages 21163 of the object relocation information 2116 may be displayed.

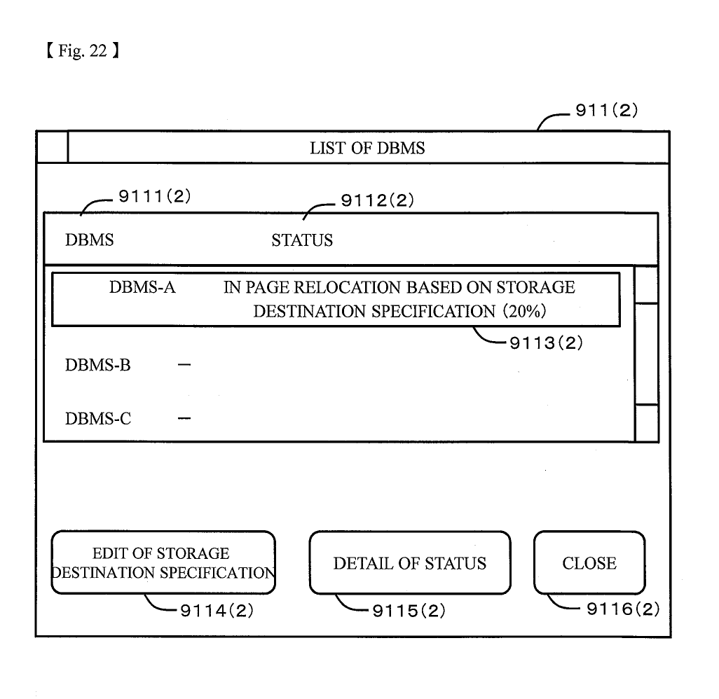

An execution button 9137 is a button for instructing the execution of the page relocation. When the execution button 9137 is pressed by the administrator, etc. of the DBMS 4412, the screen 913 of FIG. 21 is closed and the screen proceeds to the screen 911 (2) of FIG. 22 while the page relocation starts.

A cancel button 9138 is a button for canceling the instruction of execution of the page relocation. When the cancel button 9138 is pressed by the administrator, etc. of the DBMS 4412, the screen 913 of FIG. 21 is closed and the screen proceeds to the screen 912 of FIG. 20.

The screen 911 (2) of FIG. 22 illustrates the state of the screen 911 for a DBMS list during the execution of the page relocation. In order to distinguish the screen 911 (2) from the screen 911 of FIG. 19, “(2)” is given to the screen 911 (2) in FIG. 22.

In the status display area 9112 (2) of the screen 911 (2), the progress of the page relocation is displayed. In the progress, the percentage of the completed relocation is displayed by a numerical value or a graph.

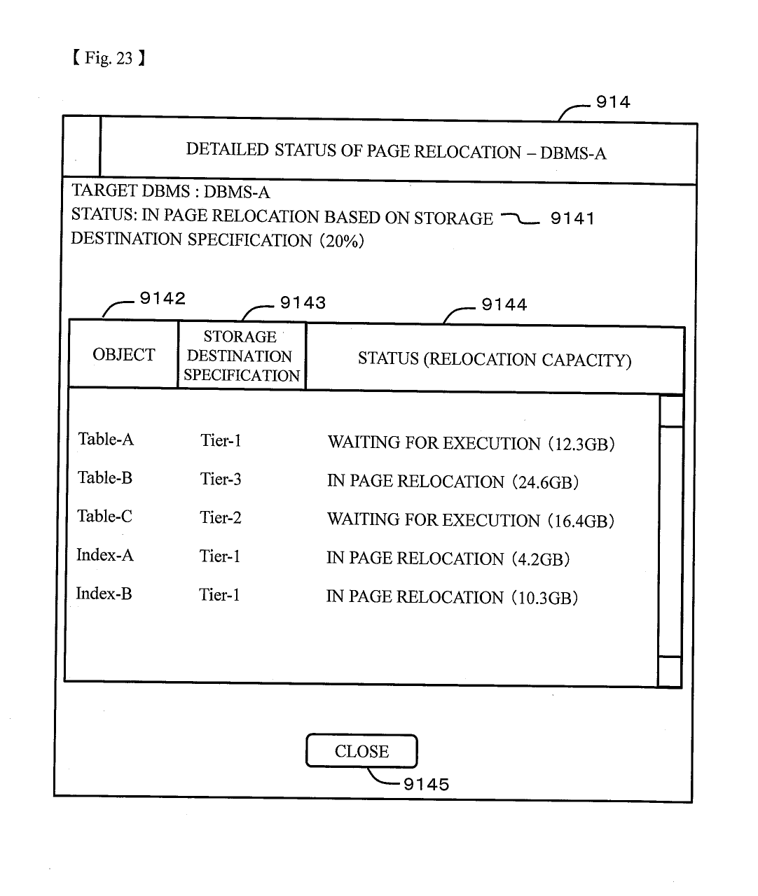

FIG. 23 illustrates a screen 914 for indicating the detailed states of the page relocation. An entire status display area 9141 displays the entire progress of the page relocation related to the selected DBMS 4412.

An object display area 9142 displays the identification name of an object. A storage destination specification display area 9143 displays the contents of the storage destination specification configured to each object. An individual status display area 9144 displays the status of execution of the page relocation for each object. The display contents of the individual status display area 9144 may be created based on a page selected in step S8112, step S8116, etc. that are processes illustrated in FIG. 15 and a page already processed.

A close button 9145 is a button for closing the screen 914 of FIG. 23. When the button 9145 is pressed by the administrator, etc. of the DBMS 4412, the screen 914 of FIG. 23 is closed and the screen returns to the screen 911 (2) of FIG. 22.

In the first embodiment described above, the management computer 20 determines each priority level of the page relocation in an object unit and instructs the page relocation depending on the priority level to the storage 30. Thus, in the first embodiment, the relocation is allowed to be performed in order of a page of an object having a high priority level. As a result, for example, an object (for example, an index of a DBMS) having high access frequency is allowed to be migrated to an appropriate tier promptly, thereby improving the response performance.

In the first embodiment, a page in which the relocation is instructed to the storage 30 is selected from relocation target pages based on the priority level of an object and the page relocation performance (upper limit value of the number of pages allowed to be processed by one page relocation process) of the storage 30. Thus, the page relocation is allowed to be completed efficiently and promptly using the relocation performance of the storage 30.

In the first embodiment, the priority level of the page relocation is allowed to be configured depending on the attribute of an object. Thus, for example, in a case of a DBMS, the priority level of an index is allowed to be configured higher than that of a table. As a result, the page relocation is allowed to be performed by giving high priority to an index having high frequency of reference, thereby improving the response performance.

In addition, in the first embodiment, the priority level related to the page relocation is allowed to be configured for each object by considering the number of I/Os. Thus, when there are two or more objects having high frequency of reference that is a technological property, a higher priority level may be configured to be given to the larger number of I/Os. As a result, the page of an object having higher usage frequency is allowed to be relocated on a priority basis.

In the first embodiment, the priority level related to the page relocation is allowed to be configured for each object by considering the structure of the page of an object. For example, in a case of an object having a type in which the latest data is appended at any time, a back page in which latest data is allocated is allowed to be relocated on a priority basis. As a result, a page of an object having high usage frequency is relocated promptly, thereby improving the response performance.

In the first embodiment, two or more policies such as a priority level configuration policy based on the attribute of an object, a priority level configuration policy based on the number of I/Os, and a priority level configuration policy based on the configuration of the page of an object are combined and allowed to be used as appropriate. Thus, a priority level is allowed to be configured properly depending on the nature and the use condition of an object. As a result, the page to be used by an object is allowed to be relocated efficiently and promptly.

In the first embodiment, the range of back pages of an object is allowed to be configured as appropriate. Thus, depending on the nature and structure of an object, the range of the back pages dealt with on a priority basis is allowed to be configured by the administrator. As a result, the range of back pages is allowed to be configured depending on the type of applications as appropriate, thereby improving the usability.

In the first embodiment, the priority level for each of the objects is allowed to be displayed on the screen 913. Thus, a page of an object to be relocated first is allowed to be checked easily by the administrator, thereby improving the usability.

### Second Embodiment

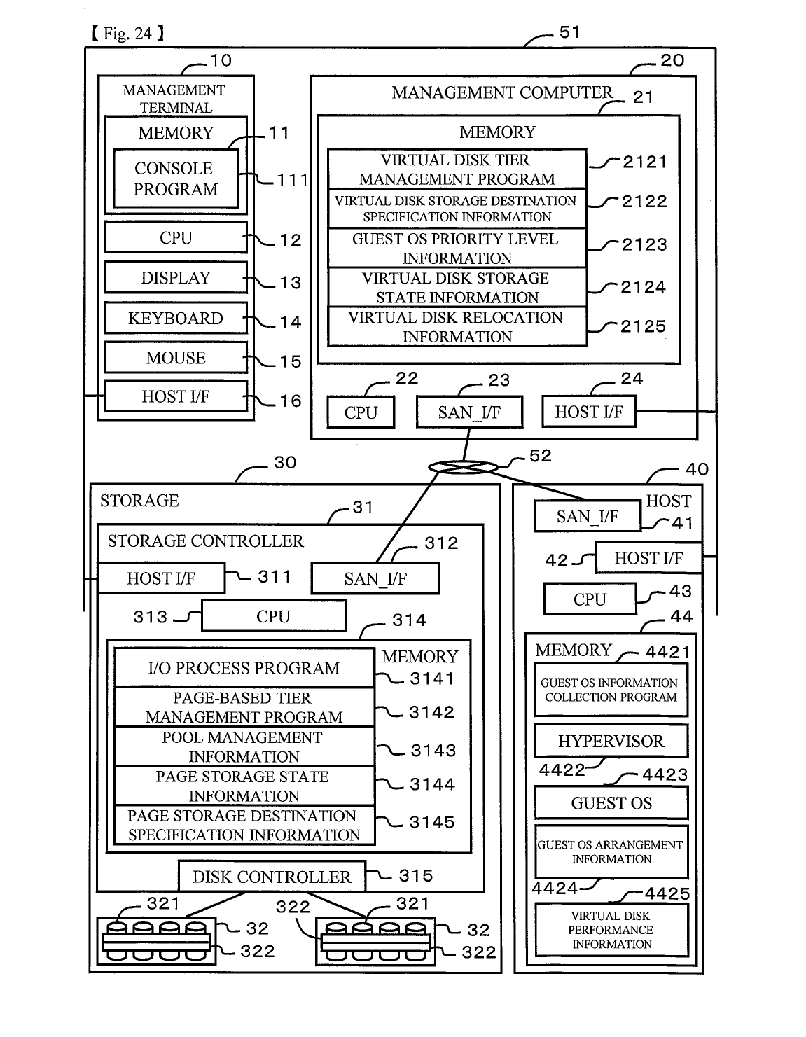

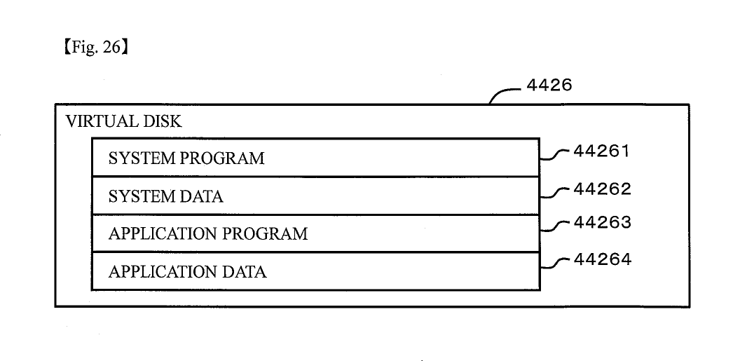

A second embodiment is described with reference to FIGS. 24 to 37. The second embodiment is an example of the object-based tier management system that targets a virtual machine environment. The second embodiment is described with reference to the drawings in order while focusing on the difference between the first embodiment and the second embodiment because there are many common points between the first embodiment and the second embodiment. In the second embodiment, the guest OS 4423 is an example of a “specific computer program.” In the second embodiment, as illustrated in FIG. 26, various pieces of information 44261, 44262, 44263, and 44264 included in a virtual disk 4426 are examples of “object.”

FIG. 24 illustrates general arrangement of a computing system according to the second embodiment. The general arrangement according to the second embodiment is different from the general arrangement according to the first embodiment illustrated in FIG. 1 in terms of a program and information stored in the memory 21 of the management computer 20, and a program and information stored in the memory 44 of the host 40.

The contents stored in the memory 21 of the management computer 20 are described. A virtual disk tier management program 2121 is a program for managing a tier for each virtual disk. The virtual disk tier management program 2121 manages the storage 30 in collaboration with a guest OS data collection program 4421 on the host 40.

Virtual disk storage destination specification information 2122 is information for identifying the storage destination of a virtual disk. The virtual disk storage destination specification information 2122 defines the tier to which the virtual disk 4426 used by the guest OS 4423 is to be stored.

Guest OS priority level information 2123 is definition information indicating the priority level of each area in a guest OS. Virtual disk relocation information 2125 is information related to a relocation target page of pages included in the virtual disk 4426 used by the guest OS 4423.

The contents of the memory 44 of the host 40 are described. The guest OS data collection program 4421 is a program for collecting information related to the guest OS 4423 and transmitting the information to the management computer 20. The guest OS data collection program 4421 provides the virtual disk tier management program 2121 with guest OS arrangement information 4424 and virtual disk performance information 4425.

The hypervisor 4422 is a foundation program for performing the execution management and operation management of the guest OS 4423. The guest OS 4423 is basic software for operating on the hypervisor 4422 and executing an application program, etc. The guest OS arrangement information 4424 is information related to internal arrangement of the guest OS 4423. The virtual disk performance information 4425 is information related to the performance of the virtual disk 4426 used by the guest OS 4423.

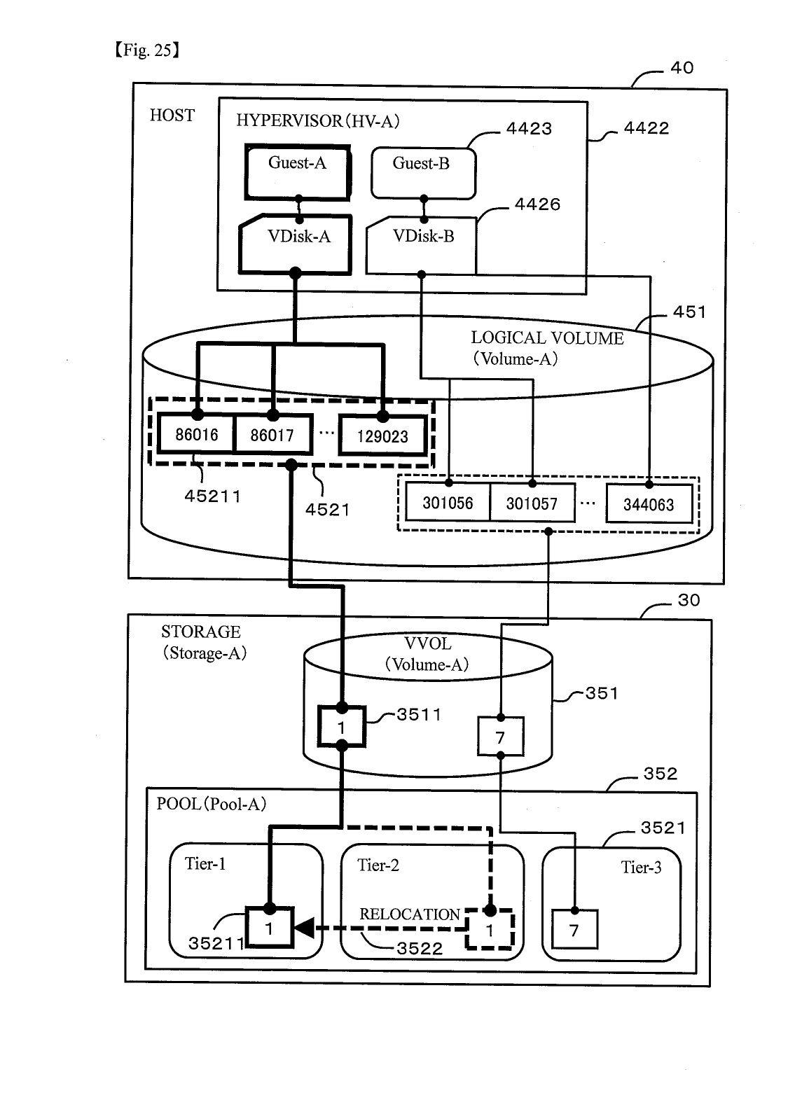

FIG. 25 illustrates a relation between the guest OS 4423 and the page relocation. The hypervisor 4422 is allowed to cause the one or more guest OSs 4423 to operate. The virtual disk 4426 is used as the memory area of the guest OS 4423. The virtual disk 4426 uses a logical block 45211 on the logical volume 451. The inside of the logical volume 451 and the storage 30 according to the second embodiment is similar to the arrangement described in FIG. 2 in the first embodiment, so that the description is omitted.

FIG. 26 illustrates the information type stored in the virtual disk 4426. In the virtual disk 4426, for example, all of or part of a system program 44261, system data 44262, an application program 44263, and application data 44264 are stored.

The system program 44261 includes one or more files holding a program that is the guest OS 4423 itself. The system data 44262 includes one or more files holding data used by the system program 44261.

The application program 44263 includes one or more files holding an application program operating on the guest OS 4423. The application data 44264 includes one or more files holding data used by the application program 44263.

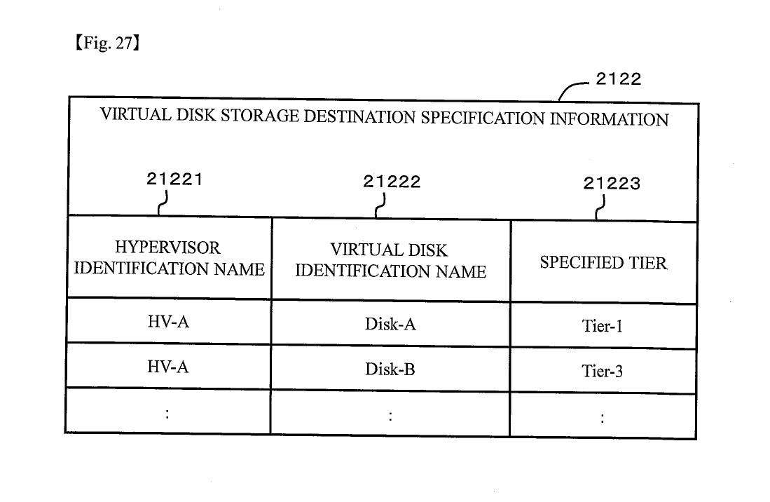

FIG. 27 illustrates an arrangement example of the virtual disk storage destination specification information 2122 used by the virtual disk tier management program 2121. The virtual disk storage destination specification information 2122 is used for identifying a tier that is to be a storage destination for each of the virtual disks 4426 used by the guest OS 4423. The virtual disk storage destination specification information 2122 is allowed to accept an input of the contents of the management terminal 10, for example, by using the management terminal 10 by the administrator of the host 40. Alternatively, the contents may be input by another means.

The virtual disk storage destination specification information 2122 includes a hypervisor identification name 21221, a virtual disk identification name 21222, and a specified tier 21223, as the attribute, and holds information in the virtual disk 4426 unit used by the guest OS 4423.

The hypervisor identification name 21121 holds an identification name for uniquely identifying the hypervisor 4422. The virtual disk identification name 21222 holds an identification name for uniquely identifying the virtual disk 4426 used by the guest OS 4423. The specified tier 21223 holds one of an identification name for uniquely identifying the tier 3521 that is a storage destination and an identification code indicating that there is no specified tier.

In the object storage destination specification information 2112, information for all of the virtual disks 4426 in the hypervisor 4422 may be not necessarily registered. For an unregistered virtual disk 4426, it may be configured that there is no specified tear, or an initial value of a specified tier may be applied to the unregistered virtual disk 4426 by defining the initial value beforehand.

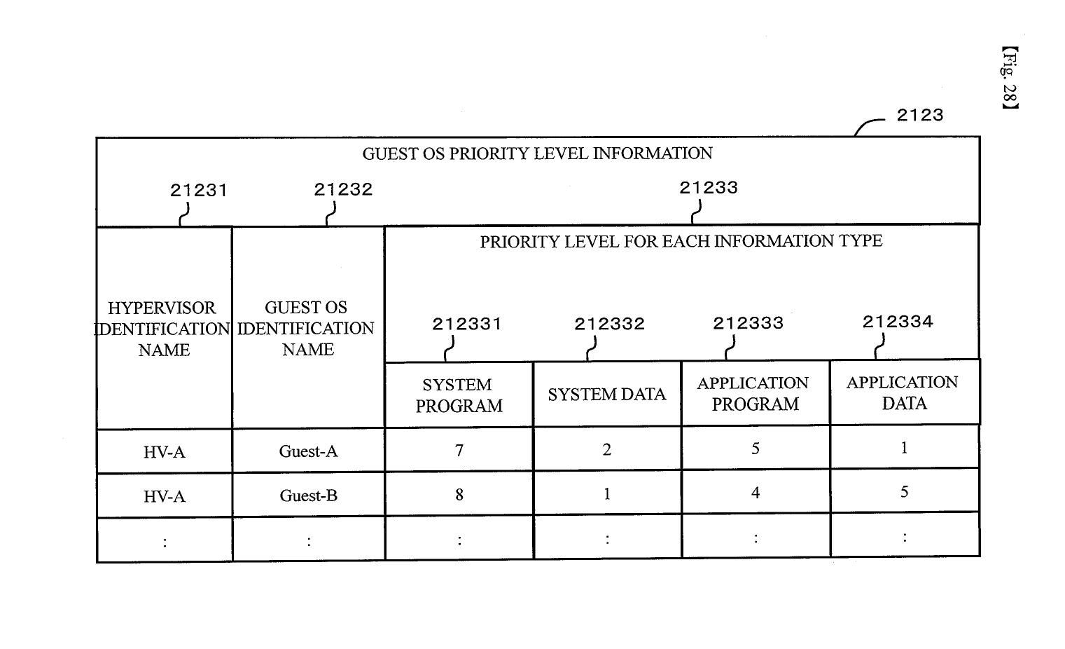

FIG. 28 is an arrangement example of guest OS priority level information 2123 used by the virtual disk tier management program 2121. The guest OS priority level information 2123 is an example of “priority level management information.” The guest OS priority level information 2123 manages the priority level of information related to the guest OS 4423 for each information type. The guest OS priority level information 2123 is allowed to accept an input of the contents of the management terminal 10, for example, using the management terminal 10 by the administrator of the host 40. Alternatively, the contents may be input by another means.

The guest OS priority level information 2123 includes a hypervisor identification name 21231, a guest OS identification name 21232, and a priority level 21233 for each information type, as the attribute, and holds information in the guest OS 4423 unit.

The hypervisor identification name 21121 holds an identification name for uniquely identifying the hypervisor 4422. The virtual disk identification name 21222 holds an identification name for uniquely identifying the virtual disk 4426 used by the guest OS 4423. A priority level 21233 for each information type holds an identification code for identifying the priority level for each information type. In the priority level 21233 for each information type, the priority level 212331 of a system program, the priority level 212332 of system data, the priority level 212333 of an application program, and the priority level 212334 of application data are included.

In the guest OS priority level information 2123, information for all of the guest OSs 4423 in the hypervisor 4422 may be not necessarily registered. To the unregistered the guest OS 4423, an initial value may be applied.

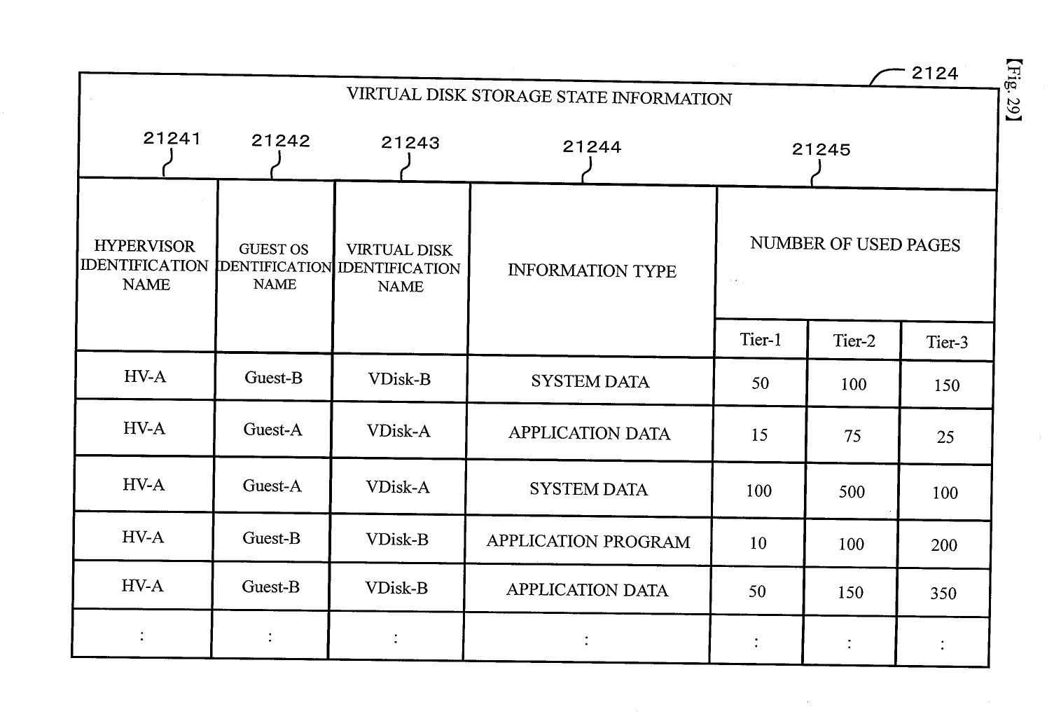

FIG. 29 is an arrangement example of virtual disk storage state information 2124 used by a virtual disk tier management program 2121. The virtual disk storage state information 2124 includes a hypervisor identification name 21241, a guest OS identification name 21242, a virtual disk identification name 21243, an information type 21244, and the number of used pages 21245, as the attribute, and holds information for each of the information types allocated in a virtual disk 4426.

The hypervisor identification name 21241 holds an identification name for uniquely identifying the hypervisor 4422. The guest OS identification name 21242 holds an identification name for uniquely identifying the guest OS 4423. The virtual disk identification name 21243 holds an identification name for uniquely identifying the virtual disk 4426 used by the guest OS 4423. The information type 21244 holds information for identifying the information type stored in the virtual disk 4426. The number of used pages 21145 is obtained by counting, for each of the tiers 3521, the number of pages 3511 corresponding to the logical block 4511 to be used, for each information type stored in the virtual disk 4426.

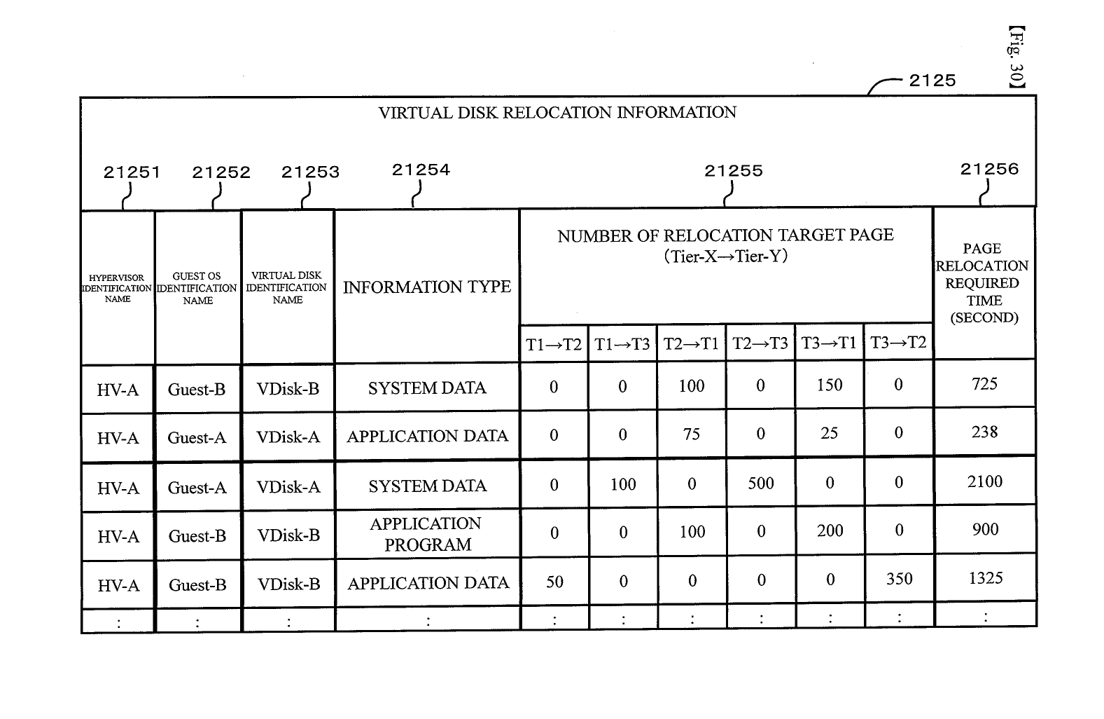

FIG. 30 is an arrangement example of the virtual disk relocation information 2125 used by the virtual disk tier management program 2121. The virtual disk relocation information 2125 includes a hypervisor identification name 21251, a guest OS identification name 21252, a virtual disk identification name 21253, an information type 21254, the number of relocation target pages 21255, and a page relocation required time 21256, as the attribute, and holds information for each of the information types allocated in the virtual disk 4426.

The hypervisor identification name 21251 holds an identification name for uniquely identifying the hypervisor 4422. The guest OS identification name 21252 holds an identification name for uniquely identifying the guest OS 4423. The virtual disk identification name 21253 holds an identification name for uniquely identifying the virtual disk 4426 used by the guest OS 4423. The information type 21254 holds information for identifying the information type stored in the virtual disk 4426. The number of relocation target pages 21255 holds the number of relocation target pages for each combination pattern of a source tier and a destination tier. The page relocation required time 21256 holds a time required for the page relocation.

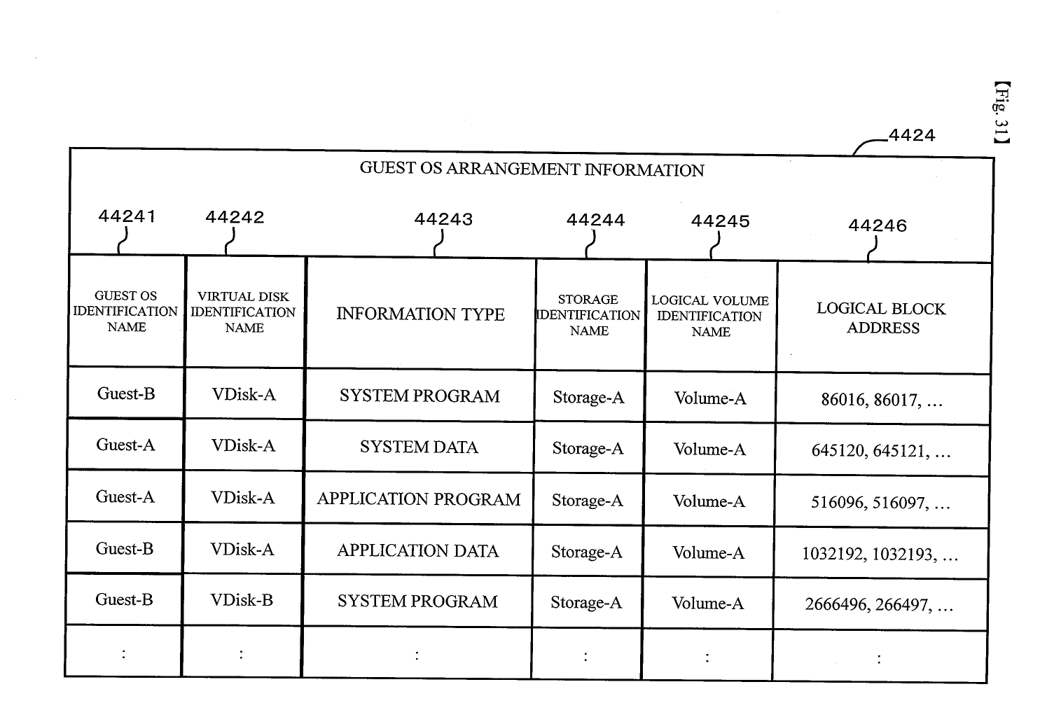

FIG. 31 is an arrangement example of the guest OS arrangement information 4424 used by a guest OS data collection program 4421. The guest OS arrangement information 4424 is created, for example, by obtaining desired information from the hypervisor 4422 in response to a request from the virtual disk tier management program 2121.

The guest OS arrangement information 4424 includes a guest OS identification name 44241, a virtual disk identification name 44242, an information type 44243, a storage identification name 44244, a logical volume identification name 44245, and a logical block address 44246, as the attribute, and holds information for each of the information types in the virtual disk 4426.

The guest OS identification name 44241 holds an identification name for uniquely identifying the guest OS 4423. The virtual disk identification name 44242 holds an identification name for uniquely identifying the virtual disk 4426 used by the guest OS 4423. The information type 44243 holds information for identifying the information type stored in the virtual disk 4426. The storage identification name 44244 holds an identification name for uniquely identifying the storage 30 providing the logical volume 451 storing the data of the virtual disk 4426. The logical volume identification name 44245 holds an identification name for uniquely identifying the logical volume 451 storing the data of the virtual disk 4426. The logical block address 44246 holds the specific number of identification codes for uniquely identifying a logical block on the logical volume 451 storing the data of the virtual disk 4426.

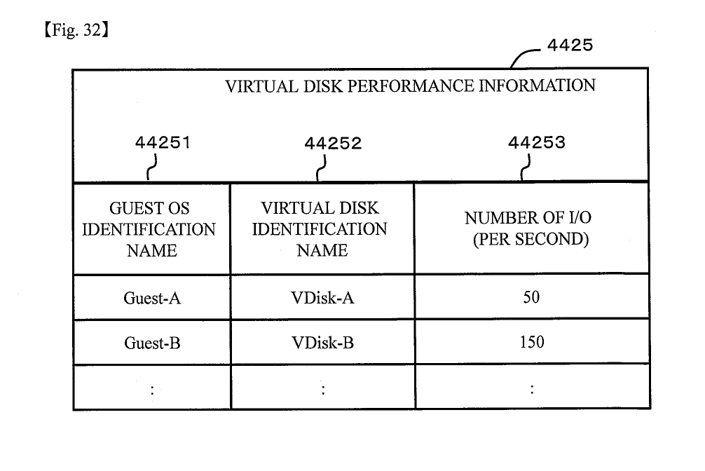

FIG. 32 is an arrangement example of virtual disk performance information 4425 used by the guest OS data collection program 4421. The virtual disk performance information 4425 is created, for example, by obtaining desired information from the hypervisor 4422 in response to a request from the virtual disk tier management program 2121.

The virtual disk performance information 4425 includes a guest OS identification name 44251, a virtual disk identification name 44252, and the number of I/Os 44253, as the attribute, and holds information in the virtual disk 4426 unit used by a guest OS 4423.

The guest OS identification name 44251 holds an identification name for uniquely identifying the guest OS 4423. The virtual disk identification name 44252 holds an identification name for uniquely identifying the virtual disk 4426. The number of I/Os 44253 holds a value indicating the number of I/Os of the virtual disk 4426.

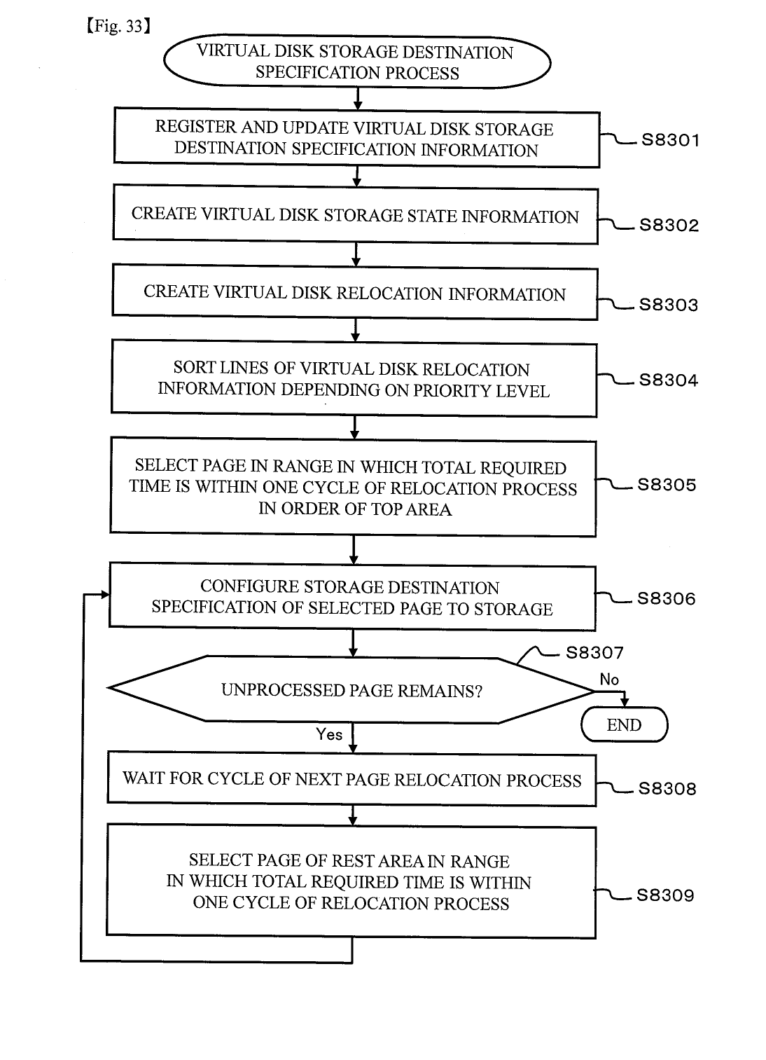

FIG. 33 is a flowchart of a process for identifying the storage destination of a virtual disk. In the system according the second embodiment, an allocation destination tier (storage destination tier) is configured to the page 3511 used by the virtual disk 4426.

FIG. 33 illustrates a series of processes for instructing the page relocation, the series of processes are executed by the virtual disk tier management program 2121. The virtual disk tier management program 2121 is allowed to refer to the guest OS arrangement information 4424 and the virtual disk performance information 4425 through the guest OS data collection program 4421 and refer to the pool management information 3143, the page storage state information 3144, and the page storage destination specification information 3145 through the page-based tier management program 3142, as appropriate.

The virtual disk tier management program 2121 prepares the virtual disk storage destination specification information 2122 (S8301). The virtual disk tier management program 2121 configures the tier 3521 that is to be an allocation destination of the virtual disk 4426 used by the guest OS 4423, to the virtual disk storage destination specification information 2122 by a specific method. For example, a method may be provided in which a value is registered to the virtual disk storage destination specification information 2122 by accessing the virtual disk tier management program 2121 through the management terminal 10 by the administrator, etc. of the host 40.

The virtual disk tier management program 2121 creates the virtual disk storage state information 2124 (S8302). The virtual disk storage state information 2124 is allowed to be created based on, for example, the guest OS arrangement information 4424 and the page storage state information 3144.

The LBA of the logical block 4511 used by information of each of the types of the guest OS 4423 is allowed to be identified by referring to the logical block address 44246 of the guest OS arrangement information 4424. The page address of the page 3511 corresponding to the logical block 4511 is allowed to be calculated by the method described in FIG. 2. The tier to which the data of a specific page address is stored is allowed to be identified by referring to the storage destination tier 31443 of the page storage state information 3144.

By the methods, the storage destination tier of the page used by the information of each of the types (hereinafter referred to as information type) related to the guest OS 4423 is allowed to be identified, and the number of pages used by each of the information types of the guest OS 4423 is allowed to be counted for each of the tiers.

The virtual disk tier management program 2121 creates the virtual disk relocation information 2125 (S8303). The virtual disk relocation information 2125 is allowed to be created based on, for example, the virtual disk storage destination specification information 2122 and the virtual disk storage state information 2124. The creation method is similar to the method for creating the object relocation information 2116 (step S8111 in FIG. 15).

The virtual disk tier management program 2121 executes a sorting process for the virtual disk relocation information 2125 (S8304). The virtual disk tier management program 2121 sorts the lines of the virtual disk relocation information 2125 in ascending order of the priority level 21233 for each information type in the guest OS priority level information 2123. When the priority level 21233 have the same values between different guest OSs 4423, high priority may be given to the guest OS 4423 having the larger number of I/Os 44252 of the virtual disk performance information 4425.

The virtual disk tier management program 2121 selects a relocation target page in a range in which the relocation is allowed to be performed within one cycle of the page relocation (S8305). The page relocation cycle is obtained by referring to the cycle 314341 of the pool management information 3143. For example, when the hypervisor 4422 that is a processing target uses “Volume-A,” the cycle is “one hour.”

Relocation target pages of which the portion is allowed to be allocated within one cycle of the page relocation are selected from the top of the virtual disk relocation information 2125. For example, when the page relocation cycle is one hour, relocation target pages are selected until a page relocation required time counted from the top line reaches 3600 seconds. In the example of FIG. 30, all pages of the information types from the first line to the third line of the virtual disk relocation information 2125 and a page up to the middle of the information type of the fourth line are the targets. That is, all relocation target pages of system data of a guest OS “Guest-B,” all relocation target pages of application data of a guest OS “Guest-A,” all relocation target pages of system data of the guest OS “Guest-A,” and a part of relocation target pages of the guest OS “Guest-B” are selected.

The virtual disk tier management program 2121 configures the storage destination specification of the page selected in step S8305 to the storage (S8306). The virtual disk tier management program 2121 configures the storage destination tier of each page selected in step S8305 or step S8310 to the page storage destination specification information 3145 through the page-based tier management program 3142.

The virtual disk tier management program 2121 determines whether or not there is an unprocessed page (S8307). In previous step S8306, when the selection process for pages of one cycle portion of the relocation process is not performed, there is no unprocessed page (S8307: No), so that the process ends. In step S8306, relocation target pages are selected by the number of pages (the number of upper limit pages) allowed to be processed by the page relocation process for one cycle portion (page relocation process for one time). Thus, in step S8306, when relocation target pages are not selected up to the number of upper limit pages, it is indicated that the selection of all relocation target pages is completed.

The virtual disk tier management program 2121 waits for subsequent page relocation timing (S8308). By the waiting process, the page relocation corresponding to the contents configured to the storage 30 in step S8306 is processed within the one cycle.

Step S8309 is substantially the same as step S8305. A difference between steps S8309 and S8305 is described. In step S8305, pages are selected in order of the information type in the top line of the virtual disk relocation information 2125. On the other hand, in step S8309, pages are selected in order of an unprocessed information type in which the configuration to the storage 30 is not completed.

In an example of FIG. 33, the case is described in which the configuration to the storage 30 is performed for each one cycle of the page relocation process in step S8306. Alternatively, when the page-based tier management program 3142 includes a function for performing the page relocation in order of the configuration of the virtual disk tier management program 2121, all relocation target pages are selected in step S8305, and the process may ends after executing step S8306.

Next, an example of an operation screen according to the second embodiment is described with reference to the drawings. The screen described below may be displayed, for example, when accessing the virtual disk tier management program 2121 using the management terminal 10 by the administrator, etc. of the host 40.

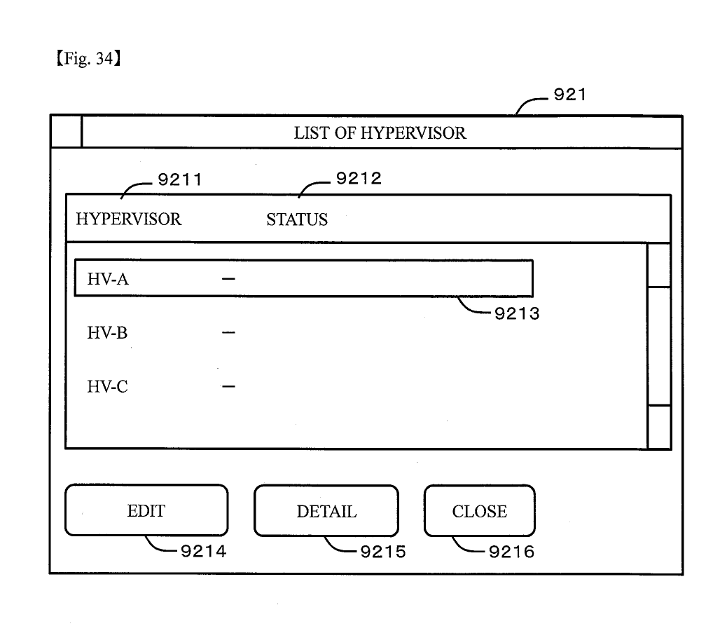

FIG. 34 illustrates a hypervisor list screen 921. The hypervisor list screen 921 displays a list of the hypervisor 4422 that is a management target of a virtual disk tier management program 2121.

In a hypervisor display area 9211, the identification name of the hypervisor 4422 that is a management target is displayed. A status display area 9212 is used for checking a status related to the page relocation process, and when the page relocation process is in progress, the status is displayed on the status display area 9212.

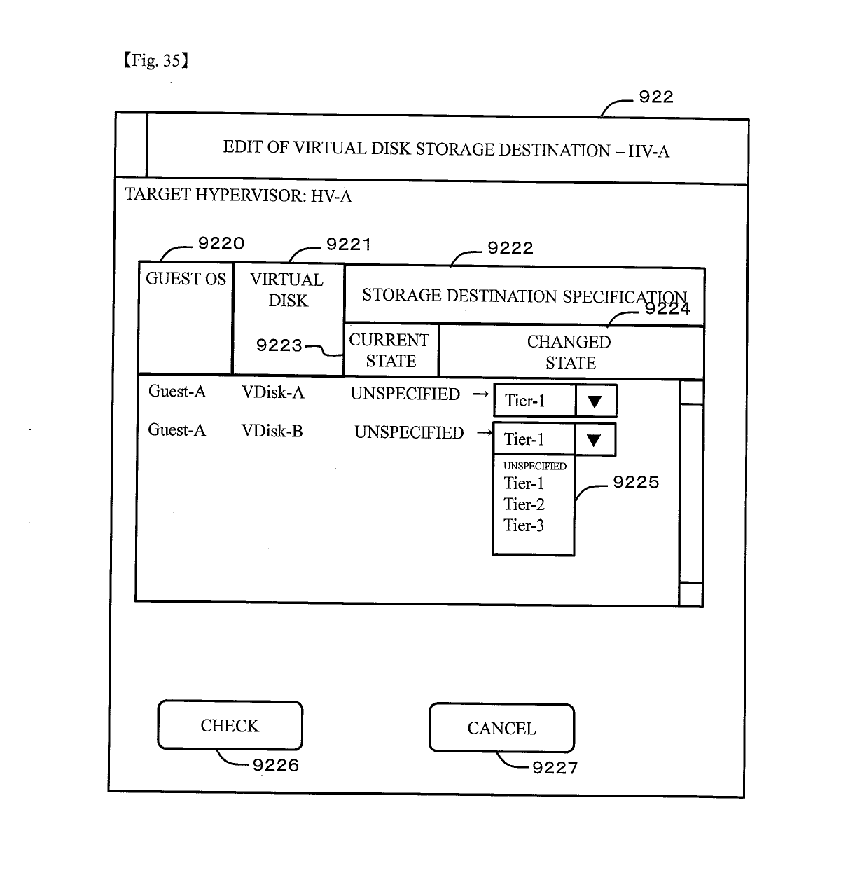

An edit button 9214 is a button for specifying a storage destination for selected hypervisor 9213. When the edit button 9214 is pressed by the administrator, etc. of the host 40, a screen of FIG. 35 is opened.

A detail button 9215 is a button for displaying the detailed information of the status of the page relocation process related to the selected hypervisor 4422. When the detail button 9215 is pressed by the administrator, etc. of the host 40, the detail screen of a status is opened. The detail screen of a status includes contents similar to the contents of screen 914 illustrated in FIG. 23. However, a text displayed in the screen is different from that of the first embodiment. A close button 9216 is a button for closing screen 921 of FIG. 34. When the close button 9216 is pressed by the administrator, etc. of the host 40, the screen 921 of FIG. 34 is closed.

FIG. 35 is an edit screen 922 of a virtual disk storage destination. The edit screen 922 is used for specifying a target storage destination tier of a virtual disk 44121 in the hypervisor 4422.

On a guest OS display area 9220, the identification name of the guest OS 4423 is displayed. On a virtual disk display area 9221, the identification name of the virtual disk 4426 is displayed. A storage destination specification area 9222 is used for specifying the storage destination of an object in a virtual disk. The storage destination specification area 9222 includes a current state display area 9223 and a change option 9224.

On the current state display area 9223, the contents of a storage destination specification configured to the virtual disk 4426 are displayed. When a storage destination is not specified, “unspecified” is displayed. The change option 9225 provides a function for specifying the storage destination of the virtual disk 4426. A desired storage destination is allowed to be specified using the change option 9225 by the administrator, etc. of the host 40.

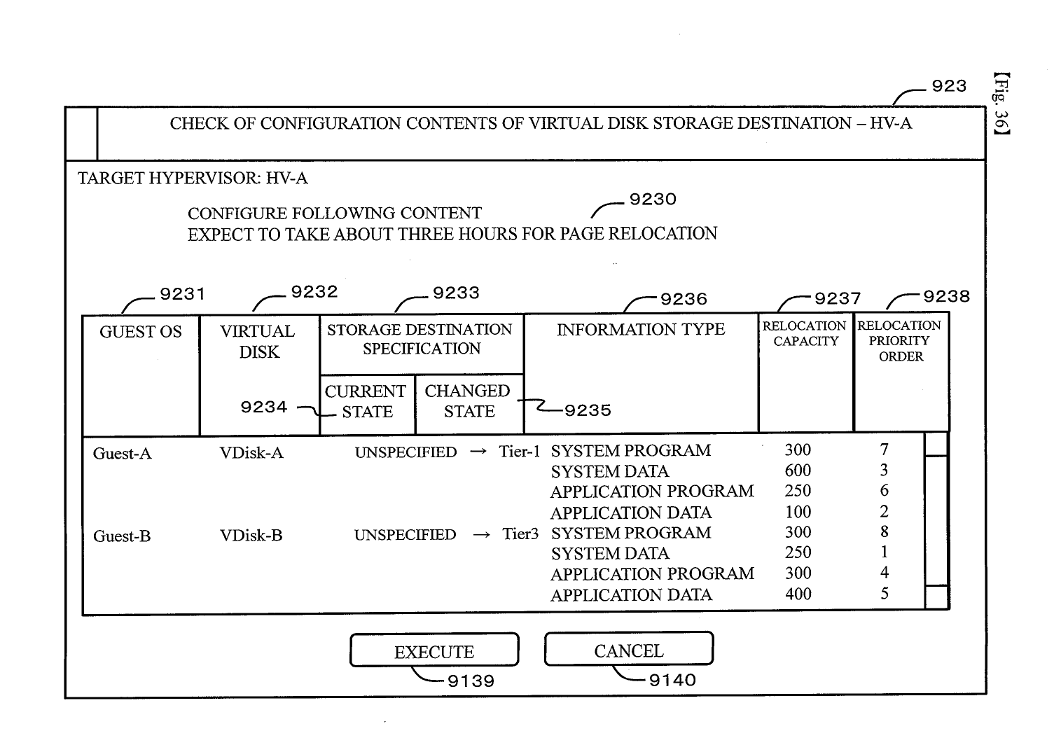

A check button 9226 is a button for fixing the contents selected by a change option 9225. When the check button 9226 is pressed by the administrator, etc. of the host 40, the screen proceeds to a screen 923 of FIG. 36. A cancel button 9227 is a button for cancelling the contents selected in the change option 9225. When the cancel button 9227 is pressed by the administrator, etc. of the host 40, the screen 922 of FIG. 35 is closed and the screen returns to the screen 921 of FIG. 34.

FIG. 36 illustrates the screen 923 for checking the configuration contents of a virtual disk storage destination and is a screen for checking the contents configured in the screen 922 of FIG. 35.

On a required time display area 9230, the time required for page relocation is displayed. For example, processes corresponding to step S8302 to step S8305 of FIG. 33 may be performed, and the total value of the page relocation required time 21256 of the virtual disk relocation information 2125 may be displayed on the required time display area 9230.

On a guest OS display area 9231, the identification name of the guest OS 4423 is displayed. On a virtual disk display area 9232, the identification name of the virtual disk 4426 is displayed.

A storage destination specification area 9233 is used for displaying the change of the storage destination specification contents of a virtual disk, and includes a current state display area 9234 and a changed state display area 9235. On the current state display area 9234, the contents of storage destination specification currently configured as the virtual disk 4426 are displayed. When the storage destination is not specified, “unspecified” is displayed. On the changed state display area 9235, the contents configured in the changed state display area 9224 of the screen 922 of FIG. 35 are displayed.

An information type 9236 displays information for identifying an information type included in the virtual disk 4426. A relocation capacity display area 9237 displays the relocation target capacity of each of the information types. The display area 9237 may display a capacity based on the number of relocation target pages 21255 of the virtual disk relocation information 2125.

A relocation priority order display area 9238 displays the priority level of the page relocation of each of the information types. The display area 9238 may display a number corresponding to the described order in the virtual disk relocation information 2125 as the priority level.

An execution button 9139 is a button for instructing the execution of page relocation. When the execution button 9139 is pressed by the administrator, etc. of the host 40, the page relocation starts while the screen 923 of FIG. 36 is closed and the screen returns to screen 921 of FIG. 34. A cancel button 9140 is a button for cancelling the execution of page relocation. When the cancel button 9140 is pressed by the administrator, etc. of the host 40, the screen 923 of FIG. 36 is closed and the screen returns to the screen 921 of FIG. 34.

In the second embodiment, the case is described in which the priority level of the page relocation is determined based on the guest OS priority level information 2123 mainly illustrated in FIG. 28. In addition to the method, for example, a priority level may be determined by a method described below.

(1) the Operation Status of a Guest OS

A guest OS is allowed to operate and stop. The priority level of page relocation may be reduced because access to the virtual disk 4426 does not occur during the stop of a guest OS. In addition, determination of the priority level of page relocation may be performed based on the operation status of a program executed on a guest OS, in addition to checking of the operation status of a guest OS. For example, when a guest OS operates and a program does not operate on the guest OS, the priority level may be reduced.

(2) the Running Schedule of a Guest OS

It is probable that a guest OS is operated based on a schedule. In this case, page relocation is performed so that the page relocation is completed before the operation of the guest OS. Thus, configuration timing to the storage 30 is adjusted so that the page relocation is completed before the operation of the guest OS. When a guest OS is about to proceed to a termination time period, the configuration to the storage 30 may be put off. It is noted that the priority level of page relocation may be determined based on the running schedule of a program executed on a guest OS instead of the running schedule of a guest OS.

(3) the Front Part or Back Part of a Page Group Used by a Guest OS

In the first embodiment, the case is described in which high priority is given to back pages of pages included in an object. High priority may be given to the page relocation of front pages or back pages of pages included in information types related to a guest OS using the method.

It is noted that the above-described (1) and (2) are allowed to be applied to the DBMS described in the first embodiment.

The above-described second embodiment is also allowed to obtain effects similar to the first embodiment.

### Third Embodiment

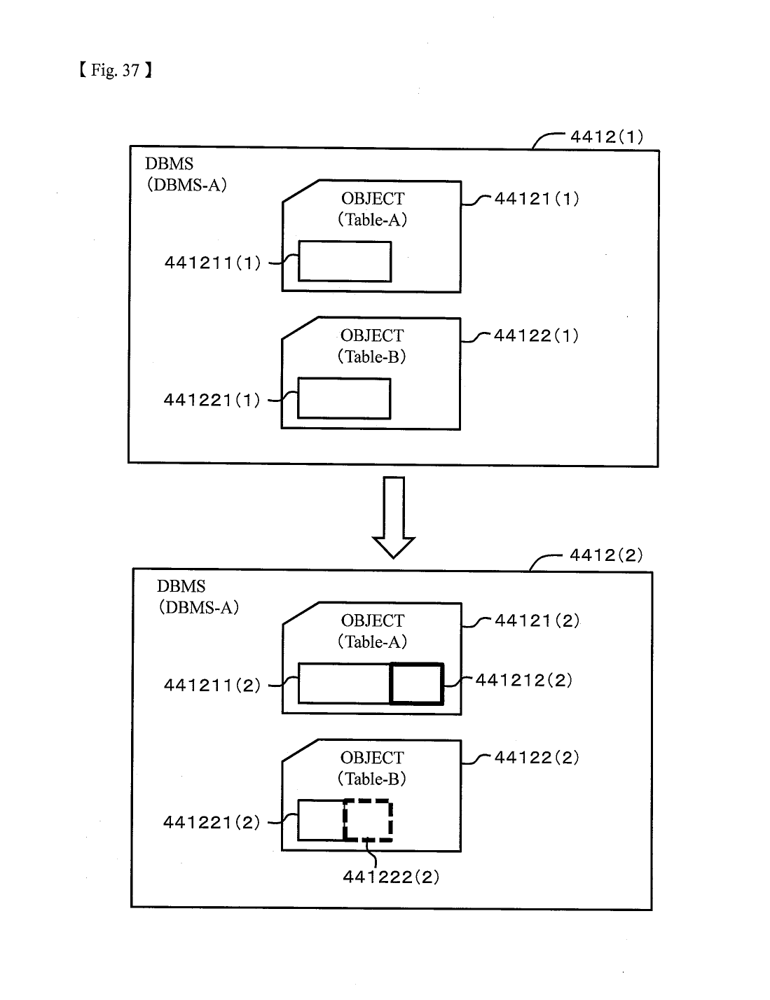

A third embodiment is described with reference to FIGS. 37 to 43. In the third embodiment, a technology is described that complements the object-based tier management system described in the first embodiment. The general system arrangement is similar to the arrangement in FIG. 1. A difference between the first embodiment and the third embodiment is mainly described below.

In the first embodiment, the process in a case in which the object storage destination specification information 2112 is registered or updated is described with reference to the flowchart of FIG. 14. Another timing at which the storage destination of a page is specified to the storage 30 may be time to change the virtual page 3511 assigned to an object.

In the DBMS 4412, when data is added to a table, the data capacity increases. On the contrary, when data is deleted from the table, the data capacity decreases. FIG. 37 illustrates a state in which the data capacity of an object increases and a state in which the data capacity of an object decreases.

On the upper side of FIG. 37, two types of the objects 44121 and 44122 are illustrated. Initial states in which data does not increase and decrease are displayed as 44121 (1) and 44122 (1), respectively. States in which data increases and decreases are displayed as 44121 (2) and 44122 (2), respectively. Any of the objects 44121 and 44122 has a type of a table.

In the initial state, “Table-A” object 44121 (1) includes a data capacity 441211 (1), and “Table-B” object 44122 (1) includes a data capacity 441221 (1).

On the lower side of FIG. 37, cases in which data capacity increases and decreases are illustrated, respectively. The increased portion 441212 (2) of a usage area is generated in “Table-A” object 44121 (2) because data is added to “Table-A” object 44121 (2). The deleted portion 441222 (2) of the usage area is generated in “Table-B” the object 44122 (2) because data is deleted from “Table-B” object 44122 (2).

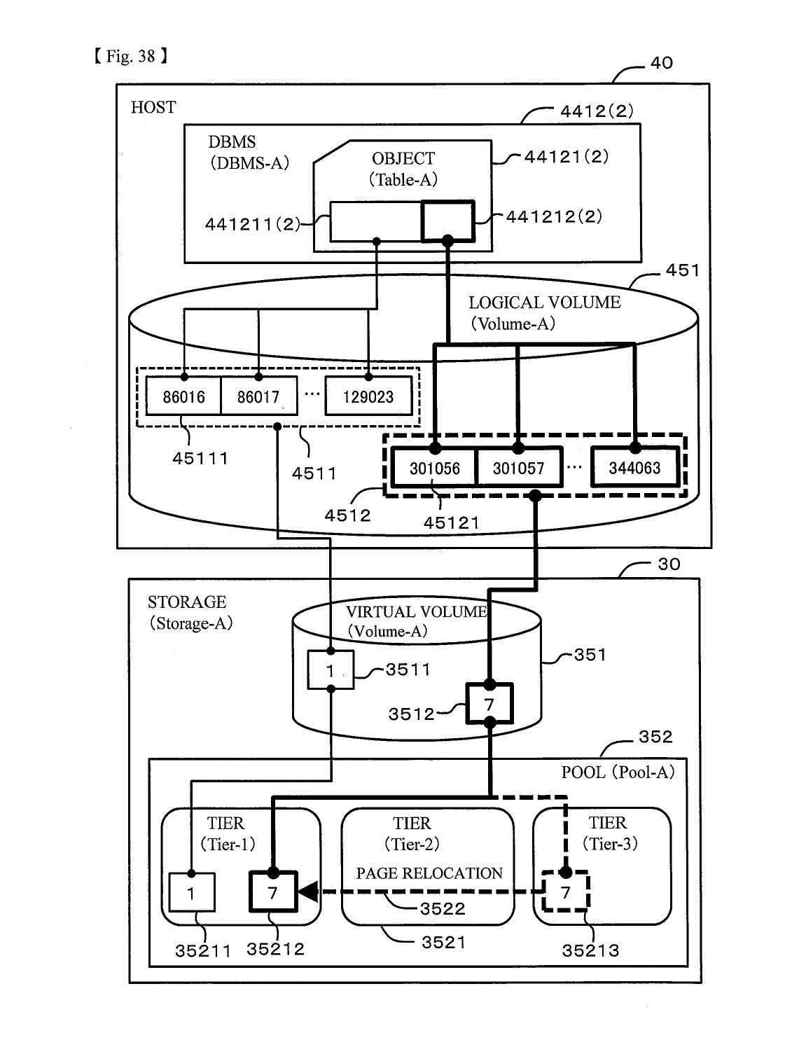

FIG. 38 illustrates a case in which the data capacity of the object 44121 increases. The increased portion 441212 (2) of a usage area of the object 44121 (2) uses a logical block 45121 on the logical volume 451. The logical block 45121 uses the virtual page 3512 on the virtual volume 351, and the virtual page 3512 uses a page 35213 of the lower tier 3521.

The page-based tier management program 3142 of the storage 30 does not detect an object by which the virtual page 3512 that is newly used in the virtual volume 351 is used. Thus, the page-based tier management program 3142 configures the value of the specified tier 31453 of the page storage destination specification information 3145 as an initial value, for example, “unspecified” for a newly assigned virtual page.

As described above, when the usage area of an object increases, a page to which a value of the specified tier 31453 of the page storage destination specification information 3145 is not configured appropriately, of pages used by the object is generated. In addition, when the usage area of an object decreases, the page is generated.

In order to deal with increase or decrease in the usage area of an object in the third embodiment, the contents of the page storage destination specification information 3145 are updated periodically or when it is detected that the usage area of an object increases or decreases.

The contents of the process are substantially the same as that of the object storage destination specification process illustrated in FIG. 14, and the process of the third embodiment is different from the object storage destination specification process illustrated in FIG. 14 in terms that step S8101 is not executed.

It is probable that the above-described process in which increase or decrease in the usage area of an object is dealt with and the process described in the first embodiment in which the object storage destination specification information 2112 is registered or updated are executed in the same period. For convenience, the process in which the increase or decrease in the usage area of an object is dealt with may be referred to as a usage area increase or decrease process below. For convenience, the process in which the object storage destination specification information 2112 is registered or updated may be referred to as a storage destination registration process below.

In the third embodiment, the storage destination of a page is specified to the storage 30 by considering the load of page relocation generated in each of the usage area increase or decrease process and the storage destination registration process. Therefore, in the third embodiment, the page relocation performance of the storage 30 is assigned to the usage area increase or decrease process and the storage destination registration process at a specific rate.

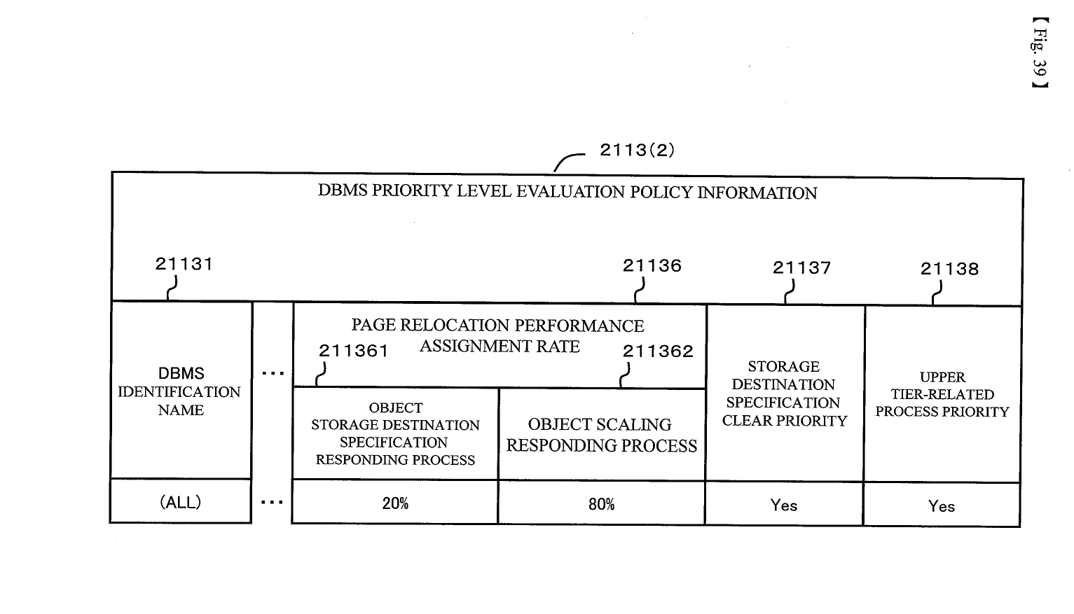

For example, 80% of the page relocation performance of the storage 30 is assigned to the usage area increase or decrease process, and the rest 20% is assigned to the storage destination registration process. For example, as illustrated in page relocation performance assignment rate 21136 of FIG. 39, the allocate rate to each of the processes may be defined as one item of the DBMS priority level evaluation policy information 2113.

As described above, the page relocation performance assignment rate 21136 indicates rates at which the page relocation performance is assigned to two or more different processes (usage area increase or decrease process and storage destination registration process). As illustrated in step S8112 of FIG. 15, etc., the value of the page relocation performance assignment rate 21136 is considered when a page is selected so as to be processed within one cycle of relocation process.

For example, a case is descried in which the number of upper limit pages allowed to be processed within one cycle of page relocation performance is 3600 pages and the assignment rate to the storage destination registration process (step S8112, etc. in FIG. 15) is 20%. In this case, in the storage destination registration process, the relocation target pages having high priority level are selected in order while configuring the number of upper limit pages as 720 pages (=3600×0.2).

When there is the excess of page relocation performance assigned to one process, the excess relocation performance may be assigned to the other process.

The priority level of page relocation may be changed by distinguishing the increase in the usage area of an object from the decrease in the usage area of an object. The capacity of the upper tier 3521 (1) having a high speed performance of an I/O process of each of the tiers 3521 of the pool 352 is generally smaller than that of the middle tier 3521 (2) and the lower tier 3521 (3). Thus, the free capacity of the upper tier 3521 (1) becomes lacking.

Therefore, when the virtual page 3511 that is no longer in use with the decrease in the usage area of an object uses a page 35212 of the upper tier 3521 (1), the storage destination specification for the virtual page 3511 that is no longer in use is cleared to return to the upper tier 3521 (1). As a result, it is desirable that the virtual page 3511 that is no longer in use is assigned to another object.

On the other hand, when the upper tier 3521 (1) is specified as the storage destination of an object, it is estimated that the object is critical in terms of performance. Thus, it is desirable that the page of the object required to be processed with high performance is relocated more immediately.

Storage destination specification clear priority 21137 and upper tier-related process priority 21138 included in the DBMS priority level evaluation policy information 2113 (2) described in FIG. 39 are definition information prepared based on the above-described background.

To the storage destination specification clear priority 21137, information that indicates whether or not high priority is given to the specification clear of a tier is configured. The high priority is given to the specification clear, when “Yes” is configured to the storage destination specification clear priority 21137, and the high priority is not given to the specification clear when “No” is configured to the storage destination specification clear priority 21137. The assignment of the page that is used as a virtual page in the upper tier is cleared when “Yes” is configured to the storage destination specification clear priority 21137.

To the upper tier-related process priority 21138, information that indicates whether or not high priority is given to the page relocation (storage destination specification) related to the upper tier is configured. The high priority is given to the page relocation when “Yes” is configured to the upper tier-related process priority 21138, and the high priority is not given to the page relocation when “No” is configured to the upper tier-related process priority 21138. There are page migration from the middle tier or lower tier to the upper tier and page migration from the upper tier to the middle tier or lower tier, as the process related to the upper tier.

When “(ALL)” is configured to the value of a DBMS identification name 2113 of FIG. 39, the configuration is applied to all of the DBMSs 4412. When the identification name of the specific DBMS 4412 is configured to an identification name 2113, the contents illustrated in FIG. 39 may be applied to the mere DBMS 4412.

The values of the storage destination specification clear priority 21137 and the upper tier-related process priority 21138 are allowed to be obtained by the filtering of a processing target page, similar to the process in the back page priority described in FIG. 14 of the first embodiment.

In the process related to a page relocation performance assignment rate 2135, a page relocation process depending on the number of I/Os (hereinafter also referred to as conventional page relocation process) may be considered. In the third embodiment, a page relocation process based on the page storage destination specification information 3145 (hereinafter also referred to as page relocation process according to the third embodiment) is described.

However, when the page relocation process according to the third embodiment and the conventional page relocation process share the page relocation performance of the storage 30, it is probable that the page relocation performance included in the storage 30 is used up by the mere page relocation process according to the third embodiment.

In order to avoid the occurrence of the problem, for example, the total of each of the rates 211361 and 211362 specified in the page relocation performance assignment rate 2135 may be configured as less than 100%.

For example, when 15% of the page relocation performance is assigned to an object storage destination specification responding process 211361 and 65% of the page relocation performance is allocated to an object scaling responding process 211362, the rest 20% (20% of the page relocation performance included in the storage 30) is allowed to be used for the conventional page relocation process.

On the contrary, it is probable that the page relocation performance of the storage 30 is almost exhausted by the mere conventional page relocation process. Therefore, for example, a new area (may be referred to as “conventional page relocation process 211353” if the area needs a name or numeral) is added to the page relocation performance assignment rate 21136. In addition, each of the values may be configured so that the total value of the value of the object storage destination specification responding process 211361, the value of the object scaling responding process 211362, and the value of the conventional page relocation process is 100%.

It is noted that the third embodiment may be applied to both of the first embodiment and the second embodiment. In addition, in the third embodiment, the case is described in which the increased or decreased usage area is processed on a priority basis, and alternatively, a portion that is not changed may be processed on a priority basis. For example, the value of the object storage destination specification responding process 211361 may be 80%, and the value of the object scaling responding process 211362 may be 20%.

### Fourth Embodiment

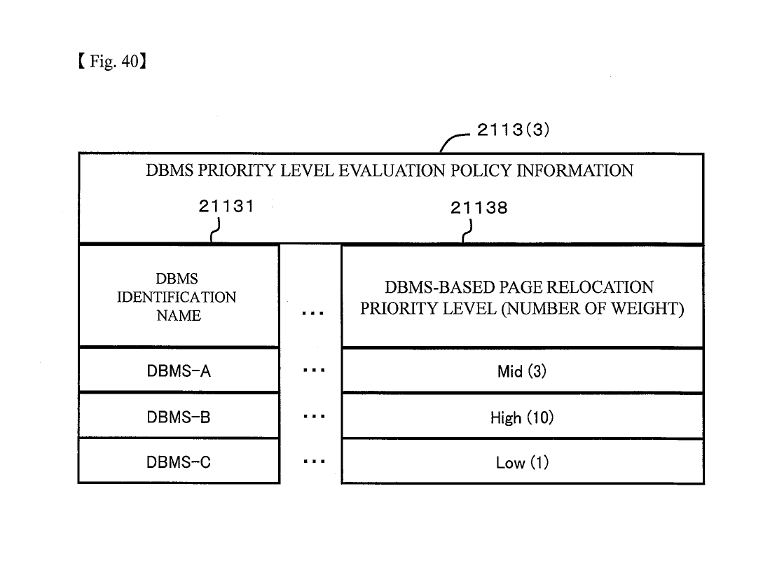

A fourth embodiment is described with reference to FIGS. 40 to 43. In the fourth embodiment, another technology for complementing the object-based tier management system described in first embodiment is described. The entire system arrangement is similar to the configuration of FIG. 1 described in the first embodiment. Description is performed by focusing on a difference of the fourth embodiment and the first embodiment.

In the first embodiment, mainly, the case is described in which the page relocation is performed based on the priority level of each of the object in the storage destination specification process for an object in one DBMS 4412. In the fourth embodiment, a case is described in which the storage destination specification of an object is performed for each of the two or more DBMSs 4412, together.

For example, it is assumed that the two or more DBMSs 4412 (1) and 4412 (2) that are page relocation targets exist on identical or different hosts 40. If the page relocation performance included in the storage 30 is almost exhausted by the mere storage destination specification process of an object related to the first DBMS 4412 (1), the progress of the page relocation of the second DBMS 4412 (2) gets stacked up. Therefore, the amount of the page relocation of each of the DBMSs 4412 (1) and 4412 (2) is controlled appropriately.

A method for adjusting the page relocation amount between the two or more DBMSs 4412 is described. In a first method, an assignment rate is configured in each of the DBMSs 4412 similar to the relocation performance assignment rate 21136 (See FIG. 39) of the third embodiment. The page relocation process in each of the DBMSs uses the page relocation performance of the storage 30 depending on the assignment rate.

In the first method, it is allowed to be avoided that the specific DBMS 4412 almost exhausts the page relocation performance of the storage 30. However, in the first method, in the DBMS 4412 having a low assignment rate, a time to complete the page relocation process is increased when a large amount of relocation target page occurs.

In a second method, the first method is improved. In the second method, a weight value for correcting a page relocation amount is configured for each of the DBMSs 4412.

FIG. 40 is an example of the DBMS priority level evaluation policy information 2113 (3) when the second method is used. A DBMS-based page relocation priority level 21138 is added to the DBMS priority level evaluation policy information 2113 (3), as the attribute. The DBMS-based page relocation priority level 21138 defines the priority level of page relocation for each of the DBMSs 4412. In the example of FIG. 40, three values of “High (10),” “Mid (3),” and “Low (1)” are employed. The numbers in parentheses indicate the weight.

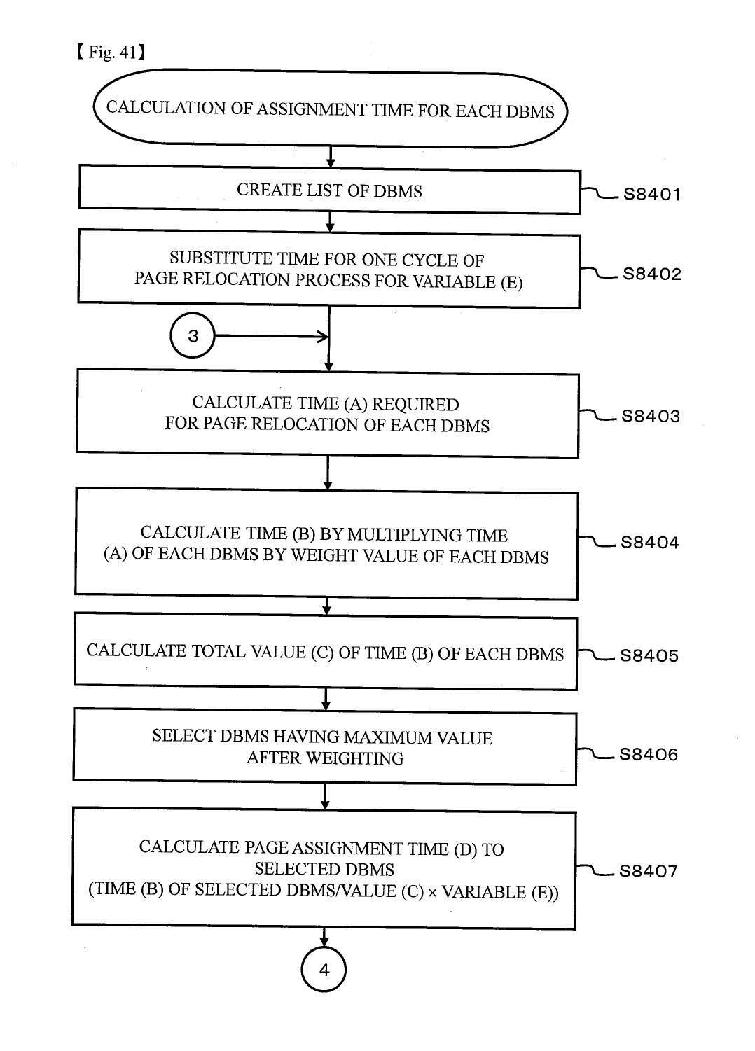

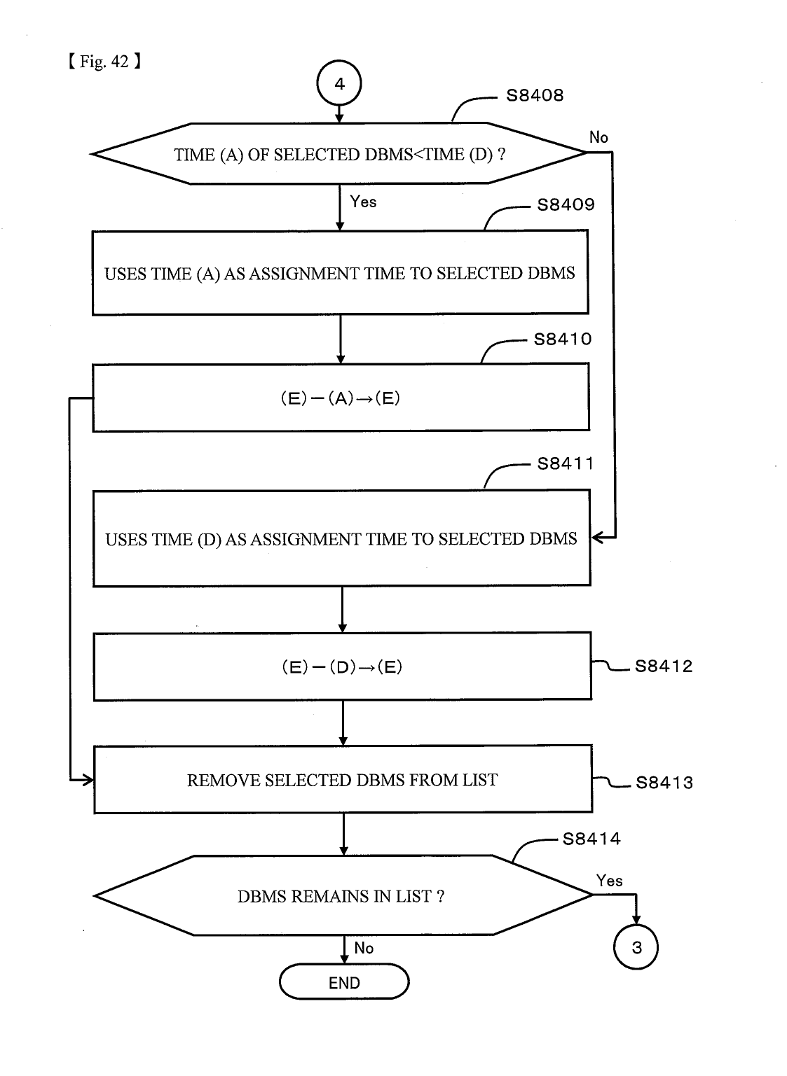

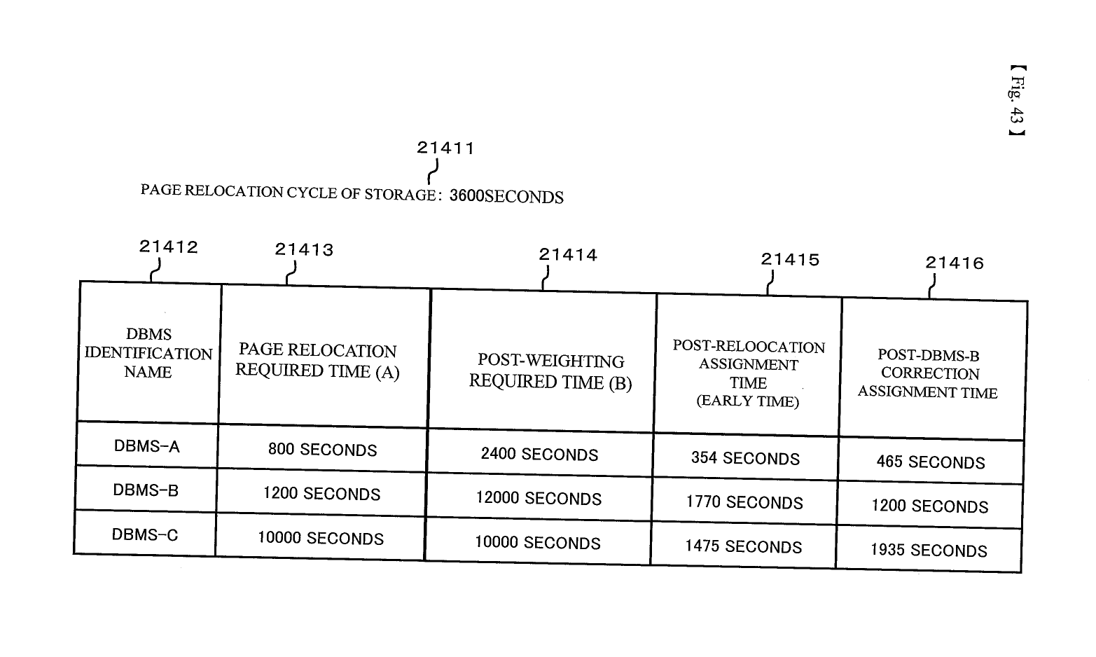

FIGS. 41 and 42 illustrate flowcharts of processes for calculating an assignment time for each of the DBMSs 4412. In the process, the page relocation process period allowed to be used for each of the DBMSs 4412 is calculated so that the total value of the time required for the page relocation process of each of the DBMSs 4412 is within one cycle of the page relocation process. The contents of the process are described below based on calculation results illustrated in FIG. 43.

First, the contents of the process are described below with reference to FIG. 41. The object tier management program 2111 creates a list of a DBMS (S8401). The list of a DBMS is allowed to be created by extracting the DBMS identification name 21131 from the DBMS priority level evaluation policy information 2113 (3) illustrated in FIG. 40 (See, the DBMS identification name 21412 of FIG. 43).

The management program 2111 substitutes the time for one cycle of the page relocation process for a variable (E) (S8402). The time of one cycle of the page relocation process is obtained by referring to the cycle 314341 of the pool management information 3143 illustrated in FIG. 9. In the fourth embodiment, description is performed while configuring the time of one cycle of the page relocation process as 3600 seconds (See, a page relocation cycle 21411 of the storage of FIG. 43).

The management program 2111 calculates a time (A) required for the page relocation for each of the DBMSs 4412 (S8403). The time required for the page relocation of each object in the DBMS 4412 is allowed to be calculated by the method described in the first embodiment.

It is assumed that the time for “DBMS-A” is 800 seconds, the time for “DBMS-B” is 1200 seconds, and the time for “DBMS-C” is 10000 seconds when the page relocation required time (A) is calculated for each of the DBMSs 4412 (See, page relocation required time 21413 of FIG. 43).

The management program 2111 calculates a time (B) by multiplying the page relocation required time (A) of each of the DBMSs 4412 by the weight value of the DBMS-based page relocation priority level 21138 illustrated in FIG. 40 (S8404).

As illustrated in FIG. 40, the weight value of “DBMS-A” is 3, the weight value of “DBMS-B” is 10, and the weight value of “DBMS-C” is 1. Thus, after the weighting, the time required for “DBMS-A” is 2400 seconds (=800 seconds×3), the time required for “DBMS-B” is 12000 seconds (=1200 seconds×10), and the time required for “DBMS-C” is 10000 seconds (=10000 seconds×1). The results are indicated in a post-weighting required time 21414 of FIG. 43.

The management program 2111 calculates the total value (C) of the time (B) obtained in step S8404 (S8405). The total value (C) is 24400 seconds (=2400 seconds+12000 seconds+10000 seconds).

The management program 2111 selects the DBMS 4412 having a maximum value after the weighting (S8406). The management program 2111 selects “DBMS-B” because the “DBMS-B” has a maximum value 10 after the weighting.

The management program 2111 calculates a page relocation time (D) assigned to the selected DBMS (S8407). Specifically, the required time (B) of the DBMS 4412 selected in step S8406 obtained after the weighting is divided by the total value (C) of required times of all of the DBMSs obtained after the weighting, and is multiplied by the value of variable (E) ((D)=((B)/(C))×(E)).

In the above-described example, 12000 seconds (See, the second line of the required time 21414 obtained after the weighting in FIG. 43) is divided by 24400 seconds that is the calculation result in step S8405, and is multiplied by 3600 seconds that is the value of variable (E), so that 1770 seconds that is an assignment time (D) is obtained (See, the second line of the assignment time 21415 obtained after the reallocation in FIG. 43).

Description is made with reference to FIG. 42. The management program 2111 determines whether or not the required time (A) of the original page relocation related to the selected DBMS 4412 exceeds the assignment time (D) calculated in step S8407 (S8408).

When the original required time (A) does not exceed the assignment time (D) (S8408: Yes), the original required time (A) is used as a page relocation time assigned to the selected DBMS 4412 (S8409). In addition, the flow proceeds to step S8410, and the management program 2111 subtracts the time (A) applied in step S8409 from the variable (E) ((E)=(E)−(A)).

When the original required time (A) exceeds the assignment time (D) (S8408: No), the management program 2111 uses the assignment time (D) calculated in step S8407 as a page relocation time assigned to the selected DBMS 4412 (S8411). In addition, the flow proceeds to step S8412, and the management program 2111 subtracts time (D) applied in step S8411 from the variable (E) ((E)=(E)−(D)).

In the above-described example, the original required time (A) related to the selected “DBMS-B” (the second line of page relocation required time 21413) is 1200 seconds, and the assignment time (D) (the second line of the assignment time 21415 obtained after the relocation in FIG. 43) is 1770 seconds. The required time of 1200 seconds is applied (See, the second line of the assignment time 21416 obtained after the DBMS-B correction in FIG. 43) because the required time (A) does not exceed the assignment time (D), and the applied 1200 seconds are subtracted from the value of 3600 seconds of the variable (E). As a result, the value of the variable (E) is 2400 seconds.

In step S8413, the management program 2111 removes the selected DBMS 4412 from the DBMS list created in step S8401. In the above-described example, the selected “DBMS-B” is removed from the DBMS list.

The management program 2111 determines whether or not the DBMS 4412 remains in the DBMS list (S8414). When the DBMS 4412 does not remain in the DBMS list (S8414: No), the process ends. When the DBMS 4412 remains in the DBMS list (S8414: Yes), the flow returns to step S8403 in FIG. 3, and the process continues.

In the above-described example, when the processes from step S8403 to step S8414 are repeated, the assignment time of “DBMS-A” is 465 seconds, and the assignment time “DBMS-C” is 1953 seconds, eventually (See, post-DBMS-B correction assignment time 21416 in FIG. 43).

In the example of FIG. 40, in the “DBMS-C”, the value of the DBMS-based page relocation priority level 21138 is Low (1), and the priority level is low. However, an assignment time that is relatively long as compared to another “DBMS-A” and “DBMS-B” is configured because 10000 seconds of the page relocation required time of the “DBMS-C” is long. Thus, in the fourth embodiment, when the priority level of the “DBMS-C” is low and a large amount of relocation target page is generated, the process period for page relocation is allowed to be configured long.

Thus, in the fourth embodiment, when the page relocation process is performed in the two or more DBMSs 4412 together, the page relocation performance of the storage 30 is allowed to be assigned depending on the weight value configured to each of the objects beforehand. Therefore, when a weight value is given to a DBMS for which high speed process is required or when a low weight value is given to a less important DBMS, the page relocation performance of the storage 30 is allowed to be effectively used depending on the nature of a DBMS.

In addition, in the fourth embodiment, the initial assignment time (D) calculated from the weight value of each of the DBMSs is not used as-is, and the initial required time (A) that is required for the page relocation and calculated in the original calculation is compared with the initial assignment time (D). In the fourth embodiment, when the initial required time (A) is shorter than the initial assignment time (D), the initial required time (A) is selected as a last assignment time. Thus, it is allowed to be suppressed to assign a page relocation time longer than necessary to a DBMS including a relocation target page allowed to be processed by the initial assignment time (A). As a result, the page relocation performance of the storage 30 is shared between the two or more DBMSs appropriately.

It is noted that there is a method that is for adjusting the page relocation amount between the two or more DBMSs 4412 and in which any of the first method and the second method is not used. For example, the evaluation method for a priority level described in the first embodiment may be applied to all of the objects of two or more DBMSs. That is, a priority level is configured to each of the objects that is a management target of the management computer 20, of each of the DBMSs. As a result, when page relocation starts between the two or more DBMSs together, depending on the priority level configured to each of the objects, the page relocation performance included in the storage 30 is allowed to be shared.

The present invention is allowed to be expressed as an invention of a computer program as described below.

“An expression 1:

A computer program causing a computer to function as a management apparatus for managing a computing system including at least one host computer and at least one storage apparatus, the storage apparatus including at least one virtual logical volume that is supplied to a specific computer program operating in the host computer and at least one pool that includes two or more storage tiers that include different performances, and executing a relocation process in which a virtual memory area comprised in the virtual logical volume is associated with a physical memory area of any of the two or more storage tiers in response to a write request from the host computer, and the physical memory area associated with the virtual memory area is allocated to a specific storage tier of the two or more storage tiers based on specific specification information for instructing a relocation destination,

the computer including a memory that is configured to store a management program for performing tier management for the two or more storage tiers and a microprocessor that is configured to execute the management program stored in the memory, the specific specification information being stored in the memory and holding information for identifying a specific storage tier in which data of two or more objects related to the specific computer program is to be stored,

the computer program causing the computer to execute, as a first tier management mode:

a priority level determination step of determining each priority level of each of the two or more objects based on priority level management information for determining a priority level related to relocation for each of the two or more objects included in the specific computer program;

a relocation information generation step of extracting a physical memory area that is a relocation target for each of the two or more objects based on the specific specification information and a storage state information indicating a current storage destination of the physical memory area corresponding to the virtual memory area;

a selection step of selecting a specific physical memory area from the extracted physical memory areas that are relocation targets based on the priority level determined for each of the two or more objects; and

an instruction step of instructing the storage apparatus to allocate data stored in the selected specific physical memory area to the physical memory area in the specific storage tier indicated in the specification information”.

### REFERENCE SIGNS LIST

10: management terminal, 20: management computer, 30: storage, 40: host, 351: virtual volume, 352: pool, and 3521: tier

1. A management apparatus for managing a computing system including at least one host computer and at least one storage apparatus, the storage apparatus including at least one virtual logical volume that is supplied to a specific computer program operating in the host computer and at least one pool that includes a plurality of storage tiers that include different performances and executing a relocation process in which a virtual memory area comprised in the virtual logical volume is associated with a physical memory area of any of the plurality of storage tiers in response to a write request from the host computer, and the physical memory area associated with the virtual memory area is allocated to a specific storage tier of the plurality of storage tiers based on specific specification information for instructing a relocation destination, and the management apparatus comprising:
a memory that is configured to store a management program for performing tier management for the plurality of storage tiers; and
a microprocessor that is configured to execute the management program stored in the memory, the specific specification information being stored in the memory and holding information for identifying a specific storage tier in which data of a plurality of objects related to the specific computer program is to be stored,
wherein the microprocessor causes the management program to execute, as a first tier management mode:
a priority level determination step of determining each priority level of each of the plurality of objects based on priority level management information for determining a priority level related to relocation for each of the plurality of objects included in the specific computer program;
a relocation information generation step of extracting a physical memory area that is a relocation target for each of the plurality of objects based on the specific specification information and a storage state information indicating a current storage destination of the physical memory area corresponding to the virtual memory area;
a selection step of selecting a specific physical memory area from the extracted physical memory areas that are relocation targets based on the priority level determined for each of the plurality of objects; and
an instruction step of instructing the storage apparatus to allocate data stored in the selected specific physical memory area to the physical memory area in the specific storage tier indicated in the specification information.

2. A management apparatus of the computing system according to claim 1, wherein
the specific physical memory area is selected based on the priority level in a range of an upper limit value determined from a relocation performance included in the storage apparatuses in the selection step.

3. A management apparatus of the computing system according to claim 2, wherein
the priority level management information is created beforehand based on an attribute of an object.

4. A management apparatus of the computing system according to claim 3, wherein
the attribute of the object includes a type of the object.

5. A management apparatus of the computing system according to claim 4, wherein
the attribute of the object includes an amount of access to the virtual memory area corresponding to the object.

6. A management apparatus of the computing system according to claim 5, wherein
a priority level of a specific virtual memory area, of the plurality of virtual memory areas corresponding to the object is configured so as to be different from a priority level of another virtual memory area in the priority level determination step.

7. A management apparatus of the computing system according to claim 6, wherein
one of a greater identifier or a greater address, and a smaller identifier or a smaller address for identifying the specific virtual memory area of the plurality of virtual memory areas corresponding to the object is treated as the specific virtual memory area in the priority level determination step.

8. A management apparatus of the computing system according to any one of claim 1, wherein
the first tier management mode is executed in one of a first case in which the specific specification information is updated and a second case in which the physical memory area related to the object increases or decreases, and
an assignment rate of the relocation performance included in the storage apparatuses is allowed to be changed from selection of the specific physical memory area based on the first case and from the selection of the specific physical memory area based on the second case in the selection step.

9. A management apparatus of the computing system according to claim 1, wherein
the specific computer program includes a first specific computer program and a second specific computer program, and
a step of determining whether the relocation performance included in the storage apparatus is more assigned to the first specific computer program or the second specific computer program is executed before the priority level determination step.

10. A management apparatus of the computing system according to claim 4, wherein
there are an index and a table in a database management system as a type of the object, and
the priority level management information is configured so that a priority level of the index is different from a priority level of the table.

11. A management apparatus of the computing system according to claim 4, wherein
there are a program file and a data file that are included in a virtual disk used by a guest operating system as the type of the object, and
the priority level management information is configured so that a priority level of the program file is different from a priority level of the data file.

12. A management apparatus of the computing system according to claim 1, wherein
the priority level is adjusted based on an activity state or activity schedule of one of the specific computer program and the object in the priority level determination step.

13. A management apparatus of the computing system according to claim 1, wherein
the priority level is allowed to be determined so that high priority is given to execution of relocation related to a storage tier including a highest performance of the plurality of storage tiers in the priority level determination step.

14. A management apparatus of the computing system according to claim 1, wherein
the microprocessor is allowed to issue an instruction for relocating each of the physical memory areas in the plurality of storage tiers to the storage apparatus based on an access amount to the virtual memory area by the host computer, as a second tier management mode, and
the microprocessor is allowed to adjust whether the relocation performance included in the storage apparatus is more assigned to relocation related to the first tier management mode or relocation related to the second tier management mode.

15. A method for managing a computing system including at least one host computer and at least one storage apparatus by a management apparatus, the storage apparatus including at least one virtual logical volume that is supplied to a specific computer program operating in the host computer and at least one pool that includes a plurality of storage tiers that include different performances and executing a relocation process in which a virtual memory area comprised in the virtual logical volume is associated with a physical memory area of any of the plurality of storage tiers in response to a write request from the host computer, and the physical memory area associated with the virtual memory area is allocated to a specific storage tier of the plurality of storage tiers based on specific specification information for instructing a relocation destination, and the specific specification information being stored in a memory of the management apparatus and holding information for identifying a specific storage tier in which data of a plurality of objects related to the specific computer program is to be stored, wherein
the management apparatus executes, as a first tier management mode:
a priority level determination step of determining each priority level of each of the plurality of objects based on priority level management information for determining a priority level related to relocation for each of the plurality of objects included in the specific computer program;
a relocation information generation step of extracting a physical memory area that is a relocation target for each of the plurality of objects based on the specific specification information and a storage state information indicating a current storage destination of the physical memory area corresponding to the virtual memory area;
a selection step of selecting a specific physical memory area from the extracted physical memory areas that are relocation targets based on the priority level determined for each of the plurality of objects; and
an instruction step of instructing the storage apparatus to allocate data stored in the selected specific physical memory area to the physical memory area in the specific storage tier indicated in the specification information.
